(19) United States
(12) Patent Application Publication
(10) Pub. No.: US 2012/0077668 A1
(43) Pub. Date: Mar. 29, 2012

(54) PHOTOCATALYST-SUPPORTING SHEET AND PRIMER FOR PHOTOCATALYST-SUPPORTING SHEET

(76) Inventors: Yasuhiro Takada, Sakura-shi (JP); Hidekazu Miyano, Sakura-shi (JP); Shinichi Kudo, Sakura-shi (JP)

(21) Appl. No.: 13/260,246

(22) PCT Filed: Apr. 27, 2010
(86) PCT No.: PCT/JP2010/057412

§ 371 Date: Dec. 1, 2011

(30) Foreign Application Priority Data
May 11, 2009 (JP) 2009-114460

(51) Int. Cl. B01J 31/06

(52) U.S. Cl. 502/158; 502/439

(57) ABSTRACT

A photocatalyst-supporting sheet includes at least an active energy ray-curable resin layer and a photocatalyst layer which are provided in that order on a substrate. The active energy ray-curable resin layer contains a composite resin (A) in which a polysiloxane segment (a1) and a vinyl polymer segment (a2) are bonded through a bond represented by general formula (3), the polysiloxane segment (a1) having a structural unit represented by general formula (1) and/or general formula (2) and having a silanol group and/or a hydrolyzable silyl group.

### TECHNICAL FIELD

The present invention relates to a photocatalyst-supporting sheet including a primer layer and a photocatalyst layer which are provided in that order on a plastic substrate, and more specifically relates to an active energy ray-curable composition used for the primer layer.

### BACKGROUND ART

Plastic sheets which support photocatalysts and photocatalyst-supporting structures each including a carrier such as a film or member which supports a photocatalyst have been known as building materials such as roof materials, storm sashes, and external wall materials or interior wall materials used for kitchens, cooking places, and bathrooms. However, it has been reported that because a plastic carrier is an organic material, the organic (carrier) causes decomposition or chalking (whitening) due to catalysis when a photocatalyst is directly supported on the plastic carrier, and thus has a problem with durability (refer to, for example, Bunsho Ohtani “Polymer Processing” Vol. 42, No. 5, p. 18 (1993), Manabu Kiyono, “Titanium Oxide” Gihodo, p. 165, etc.). Therefore, in order to solve the problem, there has been proposed a photocatalyst-supporting structure including an intermediate layer (primer layer) provided between a plastic carrier and a photocatalyst layer, the photocatalyst layer being formed on the primer layer.

On the other hand, in view of effective utilization of resources and prevention of environmental pollution, solar cells which directly convert solar light into electric energy are being developed. Since a solar cell module is used outdoors, the members used are required to have high durability and weatherability.

As described above, the members used outdoors are particularly required to have weatherability. For example, a polysiloxane-based composition and a fluoroolefin-based composition are known as members excellent in weatherability, and Patent Literature 1 discloses, as an example using such a polysiloxane-based primer layer, an example using a silicon-based material composed of silicon or silica for the primer layer.

However, the silicon-based material is excellent in weatherability but is liable to be poor in adhesion to other layers or wear resistance, and the primer layer does not adhere to the photocatalyst layer and may be separated therefrom. In addition, sintering may be required for forming the layer, and thus the silicon-based material sometimes cannot be used when plastic is used as a carrier.

An example known as the primer layer uses an active energy ray-curable resin composition, which is excellent in wear resistance, without the need for sintering to form the layer (refer to, for example, Patent Literatures 2 to 4).

For example, Patent Literature 2 discloses a substrate including a titanium oxide thin film which is formed by forming a hard coat layer composed of an ultraviolet-curable acryl resin on a resin substrate, applying titania sol on the hard coat layer, and then heat-treating the resin substrate at the softening temperature of the resin substrate.

In addition, Patent Literature 3 discloses a laminate including an undercoat layer and/or an intermediate coat layer composed of an energy ray-curable resin composition, and a coating layer of a photocatalyst-containing energy ray-curable coating composition which contains photocatalyst particles, an energy ray-curable urethane(meth)acrylate resin, and an energy ray-curable polysiloxane-modified urethane(meth)acrylate resin, the coating layer being provided on the undercoat layer and/or the intermediate coat layer.

Patent Literature 4 discloses a plastic molding including a cured material layer of an active energy ray-curable coating composition which contains a photopolymerization initiator and a polyfunctional compound containing two or more active energy ray-curable polymerizable functional groups, a cured material layer of a curable coating composition containing a compound which forms silica by curing reaction, and a layer containing a photocatalytic oxide, these layers being provided on a plastic substrate in order from the substrate side.

However, the method disclosed in Patent Literature 2 has a problem that only a titanium oxide thin film having low hardness can be obtained as the outermost surface layer because of the substantially low crystallization temperature of titania sol.

Although Patent Literature 2 discloses in paragraph 0018 that when polymethyl methacrylate is used as a resin substrate, a gel coating film is crystallized at about 84° C., but condensation reaction does not sufficiently proceed at this temperature, thereby failing to achieve satisfactory wear resistance. In addition, commercially available ultraviolet-curable acryl resins may be decomposed or cracked by photocatalysis in a long-term weatherability test.

In the method disclosed in Patent Literature 3, the energy ray-curable polysiloxane-modified urethane(meth)acrylate resin used is produced by chemical reaction bonding between functional groups in polysiloxane and functional groups in the urethane(meth)acrylate resin, and the (meth)acrylate resin with this structure also may be decomposed or cracked by photocatalysis in a long-term weatherability test.

In addition, the method disclosed in Patent Literature 4 has a problem that polysilazane is used as a compound which forms silica by curing reaction, and thus sintering is required, thereby causing limitation of the production process or the substrate used.

The inventors previously discloses an invention relating to an ultraviolet-curable polysiloxane coating material as active energy ray-curable siloxane having excellent long-term weatherability (refer to, for example, Patent Literature 5). Specifically, the ultraviolet curable coating material contains a composite resin containing a polysiloxane segment which has a silanol group and/or a hydrolyzable silyl group and a polymerizable double bond, and a polymer segment other than the polysiloxane, and a photopolymerization initiator, and a cured coating film with excellent abrasion resistance, acid resistance, alkali resistance, and solvent resistance can be formed due to two curing mechanisms including ultraviolet curing and improvement in crosslinking density of the coating film due to condensation reaction between the silanol group and/or the hydrolyzable silyl group. Also, the coating material can be preferably used as a building exterior coating and a coating for substrates such as plastic substrates which make it difficult to use a thermosetting resin composition and which are easily thermally deformed.

Further, there is an example using a photocatalyst for a solar cell member. For example, in Patent Literature 6, a light-receiving-side transparent protective member is known, in which in order to enhance the weatherability and anti-contamination property of a plastic substrate, a coating composition containing metal compound particles having a particle diameter of 1 nm to 400 nm and core-shell polymer emulsion particles is applied to the plastic substrate, the emulsion particles being produced by emulsion polymerization of a hydrolyzable silicon compound and a vinyl monomer having a glass transition point of −20° C. to 80° C. However, the coating composition can resist weatherability evaluation after exposure for 2000 hours, but the transparency of the light-receiving surface is degraded in weatherability evaluation after exposure for 3000 hours which corresponds to outdoor exposure for a long period of 10 years or more, thereby causing the problem of decreasing the energy conversion efficiency.

### CITATION LIST

### Patent Literature

PTL 1: Japanese Unexamined Patent Application Publication No. 11-91030

PTL 2: Japanese Unexamined Patent Application Publication No. 2000-1314

PTL 3: Japanese Unexamined Patent Application Publication No. 2003-165929

PTL 4: Japanese Unexamined Patent Application Publication No. 2004-195921

PTL 5: Japanese Unexamined Patent Application Publication No. 2006-328354

PTL 6: Japanese Unexamined Patent Application Publication No. 2009-253203

### SUMMARY OF INVENTION

### Technical Problem

A problem to be solved by the invention is to provide a photocatalyst-supporting sheet excellent in wear resistance and outdoor long-term weatherability (particularly chalking resistance and cracking resistance).

### Solution to Problem

As a result of keen investigation, the inventors of the present invention have found that by using, as a primer, an active energy ray-curable resin composition including a composite resin which contains a polysiloxane segment and a polymer segment other than the polysiloxane, the polysiloxane segment having a silanol group and/or a hydrolyzable silyl group and a polymerizable double bond, a stable photocatalyst layer excellent in wear resistance can be maintained without causing decomposition, chalking (whitening), or cracking due to photocatalysis even in a long-term weatherability test.

That is, the present invention provides a photocatalyst-supporting sheet including at least an active energy ray-curable resin layer and a photocatalyst layer which are provided in order on a substrate, wherein the active energy ray-curable resin layer contains a composite resin (A) in which a polysiloxane segment (a1) having a structural unit represented by general formula (1) and/or general formula (2) and a silanol group and/or a hydrolyzable silyl group, and a vinyl polymer segment (a2) are bonded through a bond represented by general formula (3).

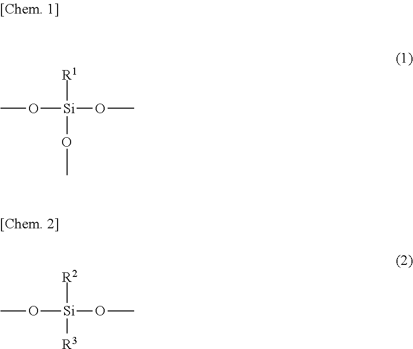

(In the general formulae (1) and (2), R¹, R², and R³ each independently represent a group having one polymerizable double bond selected from the group consisting of —R⁴—CH═CH₂, —R⁴—C(CH₃)═CH₂, —R⁴—O—CO—C(CH₃)═CH₂, and —R⁴—O—CO—CH═CH₂ (wherein R⁴ represents a single bond or an alkylene group having 1 to 6 carbon atoms), an alkyl group having 1 to 6 carbon atoms, a cycloalkyl group having 3 to 8 carbon atoms, an aryl group, or an aralkyl group having 7 to 12 carbon atoms, and at least one of R¹, R², and R³ is the group having a polymerizable double bond).

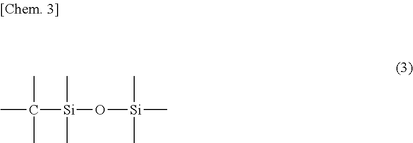

(In the general formula (3), a carbon atom constitutes a portion of the vinyl polymer segment (a2), and a silicon atom bonded only to an oxygen atom constitutes a portion of the polysiloxane segment (a1).)

Also, the present invention provides a primer for a photocatalyst-supporting sheet including a plastic substrate, the photocatalyst-supporting sheet including an active energy ray-curable resin layer composition which contains a composite resin (A) in which a polysiloxane segment (a1) having a structural unit represented by general formula (1) and/or general formula (2) and a silanol group and/or a hydrolyzable silyl group, and a vinyl polymer segment (a2) are bonded through a bond represented by general formula (3).

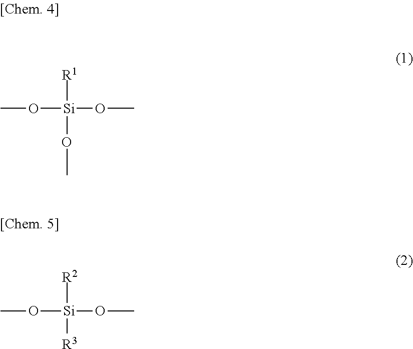

(In the general formulae (1) and (2), R¹, R², and R³ each independently represent a group having one polymerizable double bond selected from the group consisting of —R⁴—CH═CH₂, —R⁴—C(CH₃)═CH₂, —R⁴—O—CO—C(CH₃)═CH₂, and —R⁴—O—CO—CH═CH₂ (wherein R⁴ represents a single bond or an alkylene group having 1 to 6 carbon atoms), an alkyl group having 1 to 6 carbon atoms, a cycloalkyl group having 3 to 8 carbon atoms, an aryl group, or an aralkyl group having 7 to 12 carbon atoms, and at least one of R¹, R², and R³ is the group having a polymerizable double bond).

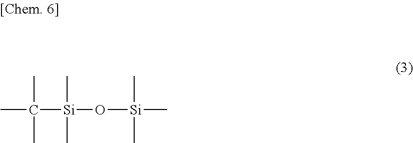

(In the general formula (3), a carbon atom constitutes a portion of the vinyl polymer segment (a2), and a silicon atom bonded only to an oxygen atom constitutes a portion of the polysiloxane segment (a1).)

### Advantageous Effects of Invention

According to the present invention, it is possible to provide a photocatalyst-supporting sheet including a stable photocatalyst layer which is excellent in wear resistance and which does not cause decomposition, chalking (whitening), or cracking due to photocatalysis even in a long-term weatherability test.

According to the present invention, the composite resin (A) has bonds represented by the general formula (3) and thus has resistance to photocatalysis. In addition, the composite resin (A) has a polymerizable double bond of an acryloyl group or the like in the structural unit having a siloxane bond represented by the general formula (1) and/or the general formula (2), and a crosslinking point derived from a siloxane bond and a crosslinking point derived from an acryloyl group are close to each other, thereby possibly providing a sea-island structure having a portion with a very high crosslinking density in a primer layer state. This is also considered as a cause for resistance to photocatalysis.

With respect to the silanol group and the hydrolyzable silyl group, hydrolysis-condensation reaction between a hydroxyl group in the silanol group and a hydrolyzable group in the hydrolyzable silyl group proceeds in parallel with ultraviolet curing reaction during the formation of a coating film by ultraviolet curing or with the lapse of time, thereby increasing the crosslinking density of the polysiloxane structure of the formed coating film. Therefore, a coating film excellent in solvent resistance can be formed. Since this reaction eliminates the need for sintering, heating is not required for curing, without causing the influence on the substrate.

Further, when a polyisocyanate (B) is mixed, the introduction of an alcoholic hydroxyl group as a functional group into the composite resin (A) permits the crosslinking density to be further increased by curing at normal temperature, and thus a primer layer excellent in long-term weatherability can be formed.

On the other hand, when the photocatalyst layer also contains any one or more of a curable resin (D) having a silanol group and/or a hydrolyzable silyl group, a curable resin (E) having a silanol group and/or a hydrolyzable silyl group and a polymerizable double bond of an acryloyl group or the like, and a curable compound (F) having a polymerizable double bond of an acryloyl group, a siloxane bond or a double bond derived from the double bond of an acryloyl group or the like occurs in an interface between the photocatalyst layer and the primer layer, thereby causing more excellent adhesion at the interface.

### DESCRIPTION OF EMBODIMENTS

### (Photocatalyst-Supporting Sheet)

A photocatalyst-supporting sheet of the present invention includes a substrate made of plastic, paper, or wood, and at least an active energy ray-curable resin layer and a photocatalyst layer which are provided in that order on the substrate.

### (Substrate)

The substrate used in the present invention is not particularly limited as long as it has a sheet shape made of plastic, paper, wood, or the like. In particular, plastic and paper are preferred in view of attachability, moldability, and easy handleability, and plastic is most preferred for outdoor use. Examples of the plastic substrate include polyolefins such as polyethylene, polypropylene, ethylene-propylene copolymers, and the like; polyesters such as polyethylene isophthalate, polyethylene terephthalate, polyethylene naphthalate, polybutylene terephthalate, and the like; polyamides such as nylon 1, nylon 11, nylon 6, nylon 66, nylon MX-D, and the like; styrene polymers such as polystyrene, styrene-butadiene block copolymer, styrene-acrylonitrile copolymer, styrene-butadiene-acrylonitrile copolymer (ABS resin), and the like; acryl polymers such as polymethyl methacrylate, methyl methacrylate/ethyl acrylate copolymer, and the like; and polycarbonate. The plastic substrate may include a single layer or a laminated structure including two or more layers. In addition, the plastic substrate may be unstretched, uniaxially stretched, or biaxially stretched. If required, the substrate may contain known additives such as an anti-static agent, a de-fogging agent, an anti-blocking agent, an ultraviolet absorber, an antioxidant, a photostabilizer, a nucleating agent, a lubricant, and the like within a range which does not inhibit the advantages of the present invention.

A surface of the plastic substrate may be subjected to known surface treatment in order to further improve adhesion to a curable resin composition of the present invention. Examples of the surface treatment include corona discharge treatment, plasma treatment, flame plasma treatment, electron beam irradiation treatment, ultraviolet irradiation treatment, and the like, and one or combination of two and more of these treatments may be performed. In addition, under coating may be performed for enhancing adhesion to an active energy ray-curable resin layer described below.

As the paper substrate, titanium paper for building materials, tissue paper for building materials, print paper, white paper, bleached or unbleached kraft paper, mixed paper formed by mixing synthetic resins, impregnated titanium paper including titanium paper impregnated with a resin such as latex, and impregnated coated titanium paper coated with latex can be used.

The paper substrate is capable of printing of a picture pattern by a known printing method. In addition, a known recoat agent containing a polyester resin or a cellulose resin as a main component can be applied to a printed surface.

The plastic substrate having a thickness in a range of 30 to 200 μm can be preferably used depending on the purpose of use. In addition, the thickness of the paper substrate is 30 to 120 g/m² in terms of basis weight, preferably 60 to 80 g/m² in terms of basis weight. In particular, the impregnated titanium paper preferably has not only high paper strength but also few bubbles between paper layers.

When the photocatalyst-supporting sheet of the present invention is used as a light receiving surface-side protective sheet for a solar cell, plastic is preferably used as the substrate.

### (Active Energy Ray-Curable Resin Layer)

At least the active energy ray-curable resin layer which serves as the primer layer provided on the substrate is characterized by containing the composite resin (A).

### (Active Energy Ray-Curable Resin Layer, Composite Resin (A))

The composite resin (A) is a composite resin (A) in which a polysiloxane segment (a1) (simply referred to as “polysiloxane segment (a1)” hereinafter) which has a structural unit represented by the general formula (1) and/or the general formula (2) and a silanol group and/or a hydrolyzable silyl group, and a vinyl polymer segment (a2) (simply referred to as “vinyl polymer segment (a2)” hereinafter) having an alcoholic hydroxyl group are bonded by a bond represented by the general formula (3). The bond represented by the general formula (3) has resistance to photocatalysis.

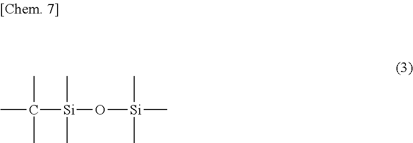

The bond represented by the general formula (3) is produced by dehydration-condensation reaction between a silanol group and/or a hydrolyzable silyl group possessed by the polysiloxane segment (a1) described below and a silanol group and/or a hydrolyzable silyl group possessed by the vinyl polymer segment (a2) described below. Therefore, in the general formula (3), a carbon atom constitutes a portion of the vinyl polymer segment (a2), and a silicon atom bonded only to an oxygen atom constitutes a portion of the polysiloxane segment (a1).

The form of the composite resin (A) may be, for example, a composite resin having a graft structure in which the polysiloxane segment (a1) is chemically bonded as a side chain to the polymer segment (a2) or a composite resin having a block structure in which the polymer segment (a2) and the polysiloxane segment (a1) are chemically bonded to each other.

(Polysiloxane Segment (a1))

The polysiloxane segment (a1) in the present invention is a segment having a structural unit represented by the general formula (1) and/or the general formula (2) and a silanol group and/or a hydrolyzable silyl group. In addition, the structural unit represented by the general formula (1) and/or the general formula (2) contains a group having a polymerizable double bond.

(Structural Unit Represented by General Formula (1) and/or General Formula (2))

The structural unit represented by the general formula (1) and/or the general formula (2) contains, as an essential component, a group having a polymerizable double bond.

Specifically, R¹, R², and R³ in the general formulae (1) and (2) each independently represent a group having one polymerizable double bond selected from the group consisting of —R⁴—CH═CH₂, —R⁴—C(CH₃)═CH², —R⁴—O—CO—C(CH₃)═CH₂, and —R⁴—O—CO—CH═CH₂ (wherein R⁴ represents a single bond or an alkylene group having 1 to 6 carbon atoms), an alkyl group having 1 to 6 carbon atoms, a cycloalkyl group having 3 to 8 carbon atoms, an aryl group, or an aralkyl group having 7 to 12 carbon atoms; and at least one of R¹, R², and R³ is the group having a polymerizable double bond. Examples of the alkylene group having 1 to 6 carbon atoms as R⁴ include a methylene group, an ethylene group, a propylene group, an isopropylene group, a butylene group, an isobutylene group, a sec-butylene group, a tert-butylene group, a pentylene group, an isopentylene group, a neopentylene group, a tert-pentylene group, a 1-methylbutylene group, a 2-methylbutylene group, a 1,2-dimethylpropylene group, a 1-ethylpropylene group, a hexylene group, an isohexylene group, a 1-methylpentylene group, a 2-methylpentylene group, a 3-methylpentylene group, a 1,1-dimethylbutylene group, a 1,2-dimethylbutylene group, a 2,2-dimethylbutylene group, a 1-ethylbutylene group, a 1,1,2-trimethylpropylene group, a 1,2,2-trimethylpropylene group, a 1-ethyl-2-methylpropylene group, a 1-ethyl-1-methylpropylene group, and the like. Among these groups, R⁴ is preferably a single bond or an alkylene group having 2 to 4 carbon atoms in view of easy availability of raw materials.

Examples of the alkyl group having 1 to 6 carbon atoms include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylbutyl group, a 2-methylbutyl group, a 1,2-dimethylpropyl group, a 1-ethylpropyl group, a hexyl group, an isohexyl group, a 1-methylpentyl group, a 2-methylpentyl group, a 3-methylpentyl group, a 1,1-dimethylbutyl group, a 1,2-dimethylbutyl group, a 2,2-dimethylbutyl group, a 1-ethylbutyl group, a 1,1,2-trimethylpropyl group, a 1,2,2-trimethylpropyl group, a 1-ethyl-2-methylpropyl group, a 1-ethyl-1-methylpropyl group, and the like.

Examples of the cycloalkyl group having 3 to 8 carbon atoms include a cyclopropyl group, a cyclobutyl group, a cyclopentyl group, a cyclohexyl group, and the like. Examples of the aryl group include a phenyl group, a naphthyl group, a 2-methylphenyl group, a 3-methylphenyl group, a 4-methylphenyl group, a 4-vinylphenyl group, a 3-isopropylphenyl group, and the like.

Examples of the aralkyl group having 7 to 12 carbon atoms include a benzyl group, a diphenylmethyl group, a naphthylmethyl group, and the like.

The expression “at least one of R¹, R², and R³ is the group having a polymerizable double bond” specifically represents that when the polysiloxane segment (a1) has only the structural unit represented by the general formula (1), R¹ is the group having a polymerizable double bond; when the polysiloxane segment (a1) has only the structural unit represented by the general formula (2), R¹ and/or R² is the group having a polymerizable double bond; and when the polysiloxane segment (a1) has the structural units represented by both the general formula (1) and the general formula (2), at least one of R¹, R², and R³ is the group having a polymerizable double bond.

In the present invention, the number of the polymerizable double bonds present in the polysiloxane segment (a1) is preferably 2 or more, more preferably 3 to 200, and most preferably 3 to 50 because a coating film with excellent wear resistance can be formed. Specifically, when the content of the polymerizable double bonds in the polysiloxane segment (a1) is 3% to 35% by weight, desired wear resistance can be achieved. The polymerizable double bond is a general term for groups which can produce free-radical propagation reaction, among a vinyl group, a vinylidene group, and a vinylene group. The content of the polymerizable double bonds indicates % by weight of the vinyl group, the vinylidene group, or the vinylene group in the polysiloxane segment.

As the group having the polymerizable double bond, any known functional group containing the vinyl group, the vinylidene group, or the vinylene group can be used. In particular, a (meth)acryloyl group represented by —R⁴—C(CH₃)═CH₂ or —R⁴—O—CO—C(CH₃)═CH₂ is preferred because it is rich in reactivity of ultraviolet curing, good in compatibility with the vinyl polymer segment (a2) described below, and capable of forming a cured coating film with excellent transparency.

The structural unit represented by the general formula (1) and/or the general formula (2) is a three-dimensional network polysiloxane structural unit in which two or three bonds of silicon are involved in crosslinking. Although the three-dimensional network structure is formed, a closed network structure is not formed, and thus storage stability is improved without causing gelling or the like during production or primer formation.

(Silanol Group and/or Hydrolyzable Silyl Group)

In the present invention, the silanol group is a silicon-containing group having a hydroxyl group directly bonded to a silicon atom. Specifically, the silanol group is preferably a silanol group produced by bonding between an oxygen atom having bonds and a hydrogen atom in the structural unit represented by the general formula (1) and/or the general formula (2).

In the present invention, the hydrolyzable silyl group is a silicon-containing group having a hydrolyzable group directly bonded to a silicon atom, and is specifically a group represented by, for example, general formula (4).

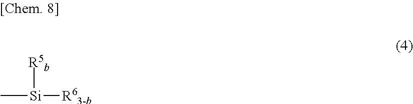

(In the general formula (4), R⁵ represents a monovalent organic group such as an alkyl group, an aryl group, or an aralkyl group; R⁶ represents a hydrolyzable group selected from the group consisting of a halogen atom, an alkoxy group, an acyloxy group, a phenoxy group, an aryloxy group, a mercapto group, an amino group, an amido group, an aminooxy group, an iminooxy group, and an alkenyloxy group; and b is an integer of 0 to 2.)

Examples of the alkyl group as R⁵ include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylbutyl group, a 2-methylbutyl group, a 1,2-dimethylpropyl group, a 1-ethylpropyl group, a hexyl group, an isohexyl group, a 1-methylpentyl group, a 2-methylpentyl group, a 3-methylpentyl group, a 1,1-dimethylbutyl group, a 1,2-dimethylbutyl group, a 2,2-dimethylbutyl group, a 1-ethylbutyl group, a 1,1,2-trimethylpropyl group, a 1,2,2-trimethylpropyl group, a 1-ethyl-2-methylpropyl group, a 1-ethyl-1-methylpropyl group, and the like.

Examples of the aryl group include a phenyl group, a naphthyl group, a 2-methylphenyl group, a 3-methylphenyl group, a 4-methylphenyl group, a 4-vinylphenyl group, a 3-isopropylphenyl group, and the like.

Examples of the aralkyl group include a benzyl group, a diphenylmethyl group, a naphthylmethyl group, and the like.

Examples of the halogen atom as R⁶ include a fluorine atom, a chlorine atom, a bromine atom, an iodine atom, and the like.

Examples of the alkoxy group include a methoxy group, an ethoxy group, a propoxy group, an isopropoxy group, a butoxy group, a sec-butoxy group, a tert-butoxy group, and the like.

Examples of the acyloxy group include formyloxy, acetoxy, propanoyloxy, butanoyloxy, pivaloyloxy, pentanoyloxy, phenylacetoxy, acetoacetoxy, benzoyloxy, naphthoyloxy, and the like.

Examples of the aryloxy group include a phenyloxy, a naphthyloxy, and the like.

Examples of the alkenyloxy group include a vinyloxy group, an allyloxy group, a 1-propenyloxy group, an isopropenyloxy group, a 2-butenyloxy group, a 3-butenyloxy group, a 2-pentenyloxy group, a 3-methyl-3-butenyloxy group, a 2-hexenyloxy group, and the like.

The hydrolyzable silyl group represented by the general formula (4) is converted to a silanol group by hydrolysis of a hydrolyzable group represented by R⁶. From the viewpoint of excellent hydrolyzability, a methoxy group and an ethoxy group are particularly preferred.

In addition, specifically, the hydrolyzable silyl group is preferably a hydrolyzable silyl group in which in the structural unit represented by the general formula (1) and/or the general formula (2), an oxygen atom having bonds is bonded to or substituted by the hydrolyzable group.

In forming a coating film by curing reaction of the group having the polymerizable double bond, hydrolysis-condensation reaction between a hydroxyl group in the silanol group and a hydrolyzable group in the hydrolyzable silyl group proceeds in parallel to the curing reaction, thereby increasing the crosslinking density of the polysiloxane structure of the formed coating film, and thus the coating film excellent in solvent resistance can be formed.

In addition, the silanol group and the hydrolyzable silyl group are used in bonding the polysiloxane segment (a1) containing the silanol group and the hydrolyzable silyl group and the vinyl polymer segment (a2) described below through the bond represented by the general formula (3).

The polysiloxane segment (a1) is not particularly limited as long as it has the structural unit represented by the general formula (1) and/or the general formula (2) and the silanol group and/or the hydrolyzable silyl group, and may be contains another group. For example, the polysiloxane segment (a1) may be, but not particularly limited to:

one in which a structural unit including the polymerizable double bond-containing group as R¹ in the general formula (1) and a structural unit including an alkyl group, such as methyl, as R¹ in the general formula (1) coexist together;

one in which a structural unit including the polymerizable double bond-containing group as R¹ in the general formula (1), a structural unit including an alkyl group, such as methyl, as R¹ in the general formula (1), and a structural unit including alkyl groups, such as methyl, as R² and R³ in the general formula (2) coexist together; or

one in which a structural unit including the polymerizable double bond-containing group as R¹ in the general formula (1) and a structural unit including alkyl groups, such as methyl, as R² and R³ in the general formula (2) coexist together.

Specific examples of the polysiloxane segment (a1) include those having the following structures:

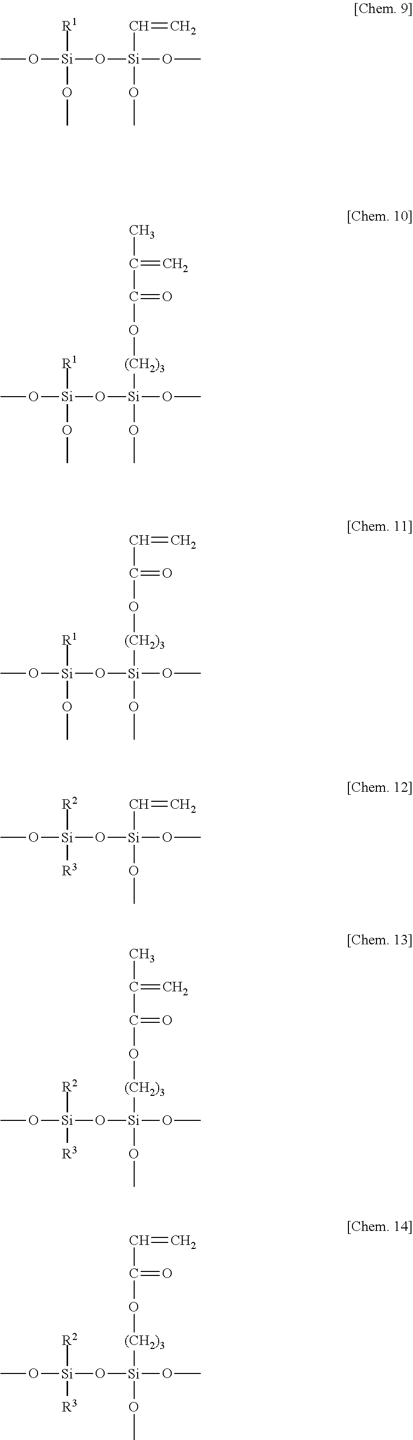

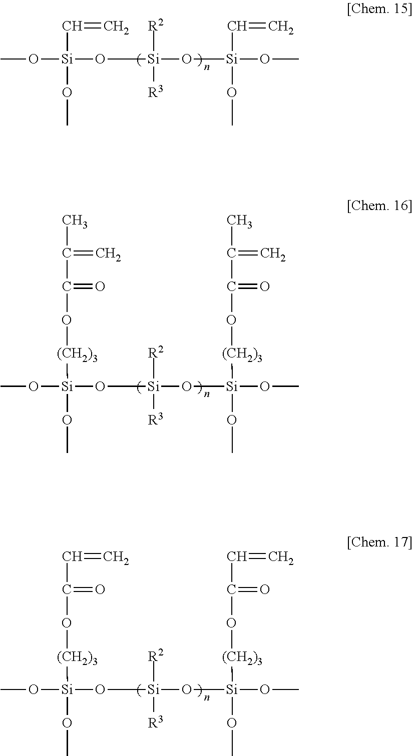

In the present invention, the polysiloxane segment (a1) is preferably contained at 10% to 65% by weight based on the total solid content in the active energy ray-curable resin layer constituting the primer layer, and both properties of weatherability and adhesion to the plastic substrate and adhesion to the photocatalyst layer can be satisfied.

(Vinyl Polymer Segment (a2))

In the present invention, the vinyl polymer segment (a2) is a vinyl polymer segment of an acryl polymer, a fluoroolefin polymer, a vinyl ester polymer, an aromatic vinyl polymer, or a polyolefin polymer. In particular, the acryl polymer segment is preferred because of the excellent transparency and glossiness of the resultant coating film.

The acryl polymer segment is produced by polymerizing or copolymerizing a general-purpose (meth)acryl monomer. The (meth)acryl monomer is not particularly limited, and a vinyl monomer can also be copolymerized. Examples of the (meth)acryl monomer include alkyl(meth)acrylates each containing an alkyl group having 1 to 22 carbon atoms, such as methyl(meth)acrylate, ethyl(meth)acrylate, n-propyl(meth)acrylate, n-butyl(meth)acrylate, isobutyl(meth)acrylate, tert-butyl(meth)acrylate, 2-ethylhexyl(meth)acrylate, lauryl(meth)acrylate, and the like; aralkyl(meth)acrylates, such as benzyl(meth)acrylate, 2-phenylethyl(meth)acrylate, and the like; cycloalkyl(meth)acrylates, such as cyclohexyl(meth)acrylate, isobornyl(meth)acrylate, and the like; ω-alkoxyalkyl(meth)acrylates, such as 2-methoxyethyl(meth)acrylate, 4-butoxybutyl(meth)acrylate, and the like; aromatic vinyl monomers, such as styrene, p-tert-butylstyrene, α-methylstyrene, vinyltoluene, and the like; carboxylic acid vinyl esters, such as vinyl acetate, vinyl propionate, vinyl pivalate, vinyl benzoate, and the like; crotonic acid alkyl esters, such as methyl crotonate, ethyl crotonate, and the like; dialkyl esters of unsaturated dibasic acids, such as dimethyl malate, di-n-butyl malate, dimethyl fumarate, dimethyl itaconate, and the like; α-olefins, such as ethylene, propylene, and the like; fluoroolefins, such as vinylidene fluoride, tetrafluoroethylene, hexafluoropropylene, chlorotrifluoroethylene, and the like; alkyl vinyl ethers, such as ethyl vinyl ether, n-butyl vinyl ether, and the like; cycloalkyl vinyl ethers, such as cyclopentyl vinyl ether, cyclohexyl vinyl ether, and the like; and tertiary amide group-containing monomers, such as N,N-dimethyl(meth)acrylamide, N-(meth)acryloyl morpholine, N-(meth)acryloyl pyrrolidine, N-vinyl pyrrolidone, and the like.

The polymerization method, solvent, or polymerization initiator for copolymerizing the monomer is not particularly limited, and the vinyl polymer segment (a2) can be produced by a known method. For example, the vinyl polymer segment (a2) can be produced by any of various methods such as a bulk radical polymerization method, a solution radical polymerization method, and a nonaqueous dispersion radical polymerization method using a polymerization initiator such as 2,2′-azobis(isobutyronitrile), 2,2′-azobis(2,4-dimethylvaleronitrile), 2,2′-azobis(2-methylbutyronitrile), tert-butyl peroxypivalate, tert-butyl peroxybenzoate, tert-butyl peroxy-2-ethylhexanoate, di-tert-butyl peroxide, cumene hydroperoxide, or diisopropyl peroxycarbonate.

The number-average molecular weight (abbreviated as “Mn”) of the vinyl polymer segment (a2) is preferably in a range of 500 to 200,000 because thickening and gelation can be prevented in producing the composite resin (A), and durability is excellent. In particular, Mn is preferably in a range of 700 to 100,000 and more preferably in a range of 1,000 to 50,000 for the reason of transfer adhesion during production of a photocatalyst-supporting sheet described below.

In order that the vinyl polymer segment (a2) is bonded with the polysiloxane segment (a1) through a bond represented by the general formula (3) to form the composite resin (A), the vinyl polymer segment (a2) contains a silanol group and/or a hydrolyzable silyl group directly bonded to a carbon bond. Since the silanol group and/or the hydrolyzable silyl group is converted to a bond represented by the general formula (3) when the composite resin (A) described below is produced, the silanol group and/or the hydrolyzable silyl group is little present in the composite resin (A) as a final product. However, even when the silanol group and/or the hydrolyzable silyl group remains in the vinyl polymer segment (a2), no problem occurs. When a coating film is formed by curing reaction of the group containing a polymerizable double bond, hydrolysis-condensation reaction proceeds between a hydroxyl group of the silanol group and a hydroxyl group of the hydrolyzable silyl group in parallel with the curing reaction, thereby increasing the crosslinking density in a polysiloxane structure of the resultant film and enabling the formation of the film excellent in solvent resistance.

Specifically, the vinyl polymer segment (a2) containing the silanol group and/or the hydrolyzable silyl group bonded directly to a carbon bond is produced by copolymerizing the general-purpose monomer and a vinyl monomer containing the silanol group and/or the hydrolyzable silyl group bonded directly to a carbon bond.

Examples of the vinyl monomer containing the silanol group and/or the hydrolyzable silyl group bonded directly to a carbon bond include vinyl trimethoxysilane, vinyl triethoxysilane, vinylmethyl dimethoxysilane, vinyl tri(2-methoxyethoxy)silane, vinyl triacetoxysilane, vinyl trichlorosilane, 2-trimethoxysilylethyl vinyl ether, 3-(meth)acryloyloxypropyl trimethoxysilane, 3-(meth)acryloyloxypropyl triethoxysilane, 3-(meth)acryloyloxypropylmethyl dimethoxysilane, 3-(meth)acryloyloxypropyl trichlorosilane, and the like. Among these, vinyl trimethoxysilane and 3-(meth)acryloyloxypropyl trimethoxysilane are preferred because hydrolysis reaction can be easily proceeded, and by-products after the reaction can be easily removed.

In addition, when a polyisocyanate (B) described below is contained, the vinyl polymer segment (a2) preferably contains an alcoholic hydroxyl group. The vinyl polymer (a2) containing an alcoholic hydroxyl group can be produced by copolymerizing a (meth)acryl monomer containing an alcoholic hydroxyl group. Specific examples of the (meth)acryl monomer containing an alcoholic hydroxyl group include various α,β-ethylenically unsaturated carboxylic acid hydroxyalkyl esters, such as 2-hydroxyethyl(meth)acrylate, 2-hydroxypropyl(meth)acrylate, 3-hydroxypropyl(meth)acrylate, 2-hydroxybutyl(meth)acrylate, 3-hydroxybutyl(meth)acrylate, 4-hydroxybutyl(meth)acrylate, 3-chloro-2-hydroxypropyl(meth)acrylate, di-2-hydroxyethyl fumarate, mono-2-hydroxyethylmonobutyl fumarate, polyethylene glycol mono(meth)acrylate, polypropylene glycol mono(meth)acrylate, “Placcel FM or Placcel FA” (caprolactone addition monomer manufactured by Daicel Chemical Industries, Ltd.), and ε-caprolactone adducts thereof. Among these, 2-hydroxyethyl(meth)acrylate is preferred because reaction is easily effected.

The amount of the alcoholic hydroxyl group is preferably appropriately determined by calculation from the amount of the polyisocyanate (B) added.

In the present invention, as described below, an active energy ray-curable monomer containing an alcoholic hydroxyl group is more preferably combined. Therefore, the amount of the alcoholic hydroxyl group in the vinyl polymer segment (a2) containing an alcoholic hydroxyl group can be determined in consideration of the amount of the alcoholic hydroxyl group-containing active energy ray-curable monomer combined. Substantially, the alcoholic hydroxyl group is preferably contained so that the hydroxyl value of the vinyl polymer segment (a2) is 30 to 300.

### (Active Energy Ray-Curable Resin Layer: Method for Producing Composite Resin (A))

Specifically, the composite resin (A) used in the present invention is produced by any one of methods described below in (Method 1) to (Method 3).

(Method 1) The vinyl polymer segment (a2) containing the silanol group and/or the hydrolyzable silyl group bonded directly to a carbon atom is produced by copolymerizing the general-purpose (meth)acryl monomer and the vinyl monomer containing the silanol group and/or the hydrolyzable silyl group directly bonded to a carbon bond. The vinyl polymer segment (a2) is mixed with a silane compound containing a silanol group and/or a hydrolyzable silyl group and a polymerizable double bond and, if required, a general-purpose silane compound, followed by hydrolysis-condensation reaction.

In this method, hydrolysis-condensation reaction occurs between the silanol group or the hydrolyzable silyl group of the silane compound containing a silanol group and/or a hydrolyzable silyl group and a polymerizable double bond and the silanol group and/or the hydrolyzable silyl group of the vinyl polymer segment (a2) containing the silanol group and/or the hydrolyzable silyl group directly bonded to a carbon bond. This reaction forms the polysiloxane segment (a1) and the composite resin (A) complexed by bonding between the polysiloxane segment (a1) and the vinyl polymer segment (a2) through the bond represented by the general formula (3).

(Method 2) The vinyl polymer segment (a2) containing the silanol group and/or the hydrolyzable silyl group directly bonded to a carbon bond is produced in the same manner as in Method 1.

On the other hand, a silane compound containing a silanol group and/or a hydrolyzable silyl group and a polymerizable double bond and, if required, a general-purpose silane compound are subjected to hydrolysis-condensation reaction, forming the polysiloxane segment (a1). Then, hydrolysis-condensation reaction is made between the silanol group and/or the hydrolyzable silyl group possessed by the vinyl polymer segment (a2) and the silanol group and/or the hydrolyzable silyl group possessed by the polysiloxane segment (a1).

(Method 3) The vinyl polymer segment (a2) containing the silanol group and/or the hydrolyzable silyl group directly bonded to a carbon bond is produced in the same manner as in Method 1. On the other hand, the polysiloxane segment (a1) is formed in the same manner as in Method 2. Further, a silane compound containing a silanol group and/or a hydrolyzable silyl group and a polymerizable double bond and, if required, a general-purpose silane compound are mixed, followed by hydrolysis-condensation reaction.

Specific examples of the silane compound containing a silanol group and/or a hydrolyzable silyl group and a polymerizable double bond used in Method 1 to Method 3 include vinyl trimethoxysilane, vinyl triethoxysilane, vinylmethyl dimethoxysilane, vinyl tri(2-methoxyethoxy)silane, vinyl triacetoxysilane, vinyl trichlorosilane, 2-trimethoxysilylethyl vinyl ether, 3-(meth)acryloyloxypropyl trimethoxysilane, 3-(meth)acryloyloxypropyl triethoxysilane, 3-(meth)acryloyloxypropylmethyl dimethoxysilane, 3-(meth)acryloyloxypropyl trichlorosilane, and the like. Among these, vinyl trimethoxysilane and 3-(meth)acryloyloxypropyl trimethoxysilane are preferred because hydrolysis reaction can be easily proceeded, and by-products after the reaction can be easily removed.

Examples of the general-purpose silane used in the Method 1 to Method 3 include various organotrialkoxysilanes, such as methyl trimethoxysilane, methyl triethoxysilane, methyl tri-n-butoxysilane, ethyl trimethoxysilane, n-propyl trimethoxysilane, iso-butyl trimethoxysilane, cyclohexyl trimethoxysilane, phenyl trimethoxysilane, phenyl triethoxysilane, and the like; various diorgano-dialkoxysilanes, such as dimethyl dimethoxysilane, dimethyl diethoxysilane, dimethyl di-n-butoxysilane, diethyl dimethoxysilane, diphenyl dimethoxysilane, methylcyclohexyl dimethoxysilane, methylphenyl dimethoxysilane, and the like; and chlorosilanes, such as methyl trichlorosilane, ethyl trichlorosilane, phenyl trichlorosilane, vinyl trichlorosilane, dimethyl dichlorosilane, diethyl dichlorosilane, diphenyl dichlorosilane, and the like. Among these, organo-trialkoxysilanes and diorgano-dialkoxysilanes are preferred because hydrolysis reaction can be easily proceeded, and by-products after the reaction can be easily removed.

In addition, a tetrafunctional alkoxysilane compound such as tetramethoxysilane, tetraethoxysilane, or tetra-n-propoxysilane or a partially hydrolyzed condensate of the tetrafunctional alkoxysilane compound can be combined within a range in which the advantages of the present invention are not impaired. When the tetrafunctional alkoxysilane compound or the partially hydrolyzed condensate thereof is combined, it is preferred that the amount of silicon atoms of the tetrafunctional alkoxysilane compound does not exceed 20 mol % of the total silicon atoms constituting the polysiloxane segment (a1).

Further, the silane compound may be combined with a metal alkoxide compound of a metal other than silicon atom, such as boron, titanium, zirconium, or aluminum, within a range in which the advantages of the present invention are not impaired. For example, the metal alkoxide compound is preferably combined within a range in which the amount of metal atoms of the metal alkoxide compound does not exceed 25 mol % of the total silicon atoms constituting the polysiloxane segment (a1).

The hydrolysis-condensation reaction in the Method 1 to Method 3 represents reaction in which the hydrolyzable groups are partially hydrolyzed with water to form hydroxyl groups, and then condensation reaction proceeds between the hydroxyl groups or between the hydroxyl groups and the hydrolyzable groups. The hydrolysis-condensation reaction can be proceeded by a known method, but a simple and preferred method is to proceed the reaction by supplying water and a catalyst in the production process.

Examples of the catalyst used include inorganic acids, such as hydrochloric acid, sulfuric acid, phosphoric acid, and the like; organic acids, such as p-toluenesulfonic acid, monoisopropyl phosphate, acetic acid, and the like; inorganic bases, such as sodium hydroxide, potassium hydroxide, and the like; titanates, such as tetraisopropyl titanate, tetrabutyl titanate, and the like; various basic nitrogen atom-containing compounds, such as 1,8-diazabicyclo[5.4.0]undecene-7 (DBU), 1,5-diazabicyclo[4.3.0]nonene-5 (DBN), 1,4-diazabicyclo[2.2.2]octane (DABCO), tri-n-butylamine, dimethylbenzylamine, monoethanolamine, imidazole, 1-methylimidazole, and the like; quaternary ammonium salts, such as tetramethyl ammonium salts, tetrabutyl ammonium salts, dilauryldimethyl ammonium salts, and the like, each of which contains, as pairing anion, chloride, bromide, carboxylate, or hydroxide; tin carboxylates, such as dibutyltin diacetate, dibutyltin dioctoate, dibutyltin dilaurate, dibutyltin diacetylacetate, tin octylate, tin stearate, and the like. These catalysts may be used alone or in combination of two or more.

The amount of the catalyst added is not particularly limited but is generally preferably within a range of 0.0001% to 10% by weight, more preferably in a range of 0.0005% to 3% by weight, most preferably in a range of 0.001% to 1% by weight, based on the total amount of the compounds each containing the silanol group or the hydrolyzable silyl group.

The amount of the water supplied is preferably 0.05 mole or more, more preferably 0.1 mole or more, most preferably 0.5 mole or more, per mole of the silanol group or hydrolyzable silyl group possessed by the compounds each containing the silanol group or the hydrolyzable silyl group.

The catalyst and water may be supplied at a time or successively, or a mixture of the catalyst and water may be supplied.

The proper reaction temperature of the hydrolysis-condensation reaction in the Method 1 to Method 3 is in a range of 0° C. to 150° C., preferably in a range of 20° C. to 100° C. As the reaction pressure, the reaction may be performed under any of the conditions of normal pressure, increased pressure, and reduced pressure. In addition, alcohol and water produced as by-products in the hydrolysis-condensation reaction may be removed by a method such as distillation according to demand.

In Method 1 to Method 3, the feed ratio of each of the compounds is appropriately selected according to the desired structure of the composite resin (A) used in the present invention. In particular, the composite resin (A) is produced so that the content of the polysiloxane segment (a1) is preferably 30% to 95% by weight and more preferably 30% to 75% by weight because of the excellent durability of the resultant coating film.

In Method 1 to Method 3, a specific method for forming a composite by bonding, in blocks, the polysiloxane segment and the vinyl polymer segment uses, as an intermediate, a vinyl polymer segment with a structure which has the silanol group and/or the hydrolyzable silyl group at one or both of the ends of a polymer chain. For example, in Method 1, the vinyl polymer segment is mixed with a silane compound containing a silanol group and/or a hydrolyzable silyl group and a polymerizable double bond and, if required, a general-purpose silane compound, followed by hydrolysis-condensation reaction.

On the other hand, in Method 1 to Method 3, a specific method for forming a composite by grafting the polysiloxane segment to the vinyl polymer segment uses, as an intermediate, a vinyl polymer segment having a structure in which the silanol group and/or the hydrolyzable silyl group is randomly distributed to the main chain of the vinyl polymer segment. For example, in Method 2, the silanol group and/or the hydrolyzable silyl group possessed by the vinyl polymer and the silanol group and/or the hydrolyzable silyl group possessed by the polysiloxane segment are subjected to hydrolysis-condensation reaction.

### (Active Energy Ray-Curable Resin Layer, Polyisocyanate (B))

When the vinyl polymer segment (a2) in the composite resin (A) has an alcoholic hydroxyl group, the polyisocyanate (B) is preferably combined. In this case, the polyisocyanate (B) is preferably contained at 5% to 50% by weight based on the total solid content of the active energy ray-curable resin layer. When the polyisocyanate (B) is contained in this range, a coating film particularly excellent in long-term outdoor weatherability (specifically, crack resistance) can be formed. This is supposed to be due to a urethane bond which is formed as a soft segment by reaction between the polyisocyanate and hydroxyl groups in the system (the hydroxyl group in the vinyl polymer segment (a2) and a hydroxyl group in an active energy ray-curable monomer having an alcoholic hydroxyl group described below), the soft segment functioning to reduce stress concentration due to curing by the polymerizable double bond.

The polyisocyanate (B) used is not particularly limited, and a known polyisocyanate can be used. However, a polyisocyanate produced using, as a main raw material, an aromatic diisocyanate such as tolylene diisocyanate or diphenylmethane-4,4′-diisocyanate, or an aralkyl diisocyanate such as metha-xylylene diisocyanate or α,α,α′,α′-tetramethyl-metha-xylylene diisocyanate, is preferably used in the minimum amount because of the problem of yellowing a cured coating film in long-term outdoor exposure.

As the polyisocyanate used in the present invention, an aliphatic polyisocyanate produced using aliphatic diisocyanate as a raw material is preferred from the viewpoint of long-term outdoor use. Examples of the aliphatic diisocyanate include tetramethylene diisocyanate, 1,5-pentamethylene diisocyanate, 1,6-hexamethylene diisocyanate (hereinafter, abbreviated as “HDI”), 2,2,4- (or 2,4,4)-trimethyl-1,6-hexamethylene diisocyanate, lysine isocyanate, isophorone diisocyanate, hydrogenated xylene diisocyanate, hydrogenated diphenylmethane diisocyanate, 1,4-diisocyanatocyclohexane, 1,3-bis(diisocyanatomethyl)cyclohexane 4,4′-dicyclohexylmethane diisocyanate, and the like. Among these, HDI is particularly preferred from the viewpoint of cracking resistance and cost.

As the aliphatic polyisocyanate produced from the aliphatic diisocyanate, allophanate-type polyisocyanate, biuret-type polyisocyanate, adduct-type polyisocyanate, and isocyanurate-type polyisocyanate can be used, and any one of these can be preferably used.

As the polyisocyanate, a so-called block polyisocyanate compound which is blocked with a blocking agent can also be used. Examples of the blocking agent include alcohols such as methanol, ethanol, lactates, and the like; phenolic hydroxyl group-containing compounds such as phenol, salicylates, and the like; amides such as ε-caprolactam, 2-pyrrolidone, and the like; oximes such as acetone oxime, methyl ethyl ketoxime, and the like; and active methylene compounds such as methyl acetoacetate, ethyl acetoacetate, acetylacetone, and the like.

The content of isocyanate groups in the polyisocyanate (B) is preferably 3% to 30% by weight in view of cracking resistance and wear resistance of the resultant cured coating film. When the content of isocyanate groups in the polyisocyanate (B) exceeds 30%, the molecular weight of the polyisocyanate may be decreased, thereby not exhibiting the cracking resistance due to stress relaxation.

Heating is not particularly required for reaction between the polyisocyanate and the hydroxyl groups in the system (the hydroxyl group in the vinyl polymer segment (a2) and the hydroxyl group in the active energy ray-curable monomer having an alcoholic hydroxyl group). For example, in the case of ultraviolet curing, the reaction gradually proceeds by allowing to stand at room temperature after coating and ultraviolet irradiation. If required, the reaction between the alcoholic hydroxyl group and the isocyanate may be accelerated by heating at 80° C. for several minutes to several hours (20 minutes to 4 hours) after ultraviolet irradiation. In this case, if required, a known urethane catalyst may be used. The urethane catalyst is appropriately selected according to the desired reaction temperature.

### (Active Energy Ray-Curable Resin Layer, Other Compounds)

The active energy ray-curable resin layer used in the present invention can be cured by active energy rays because the composite resin (A) contains the polymerizable double bond. Examples of the active energy rays include ultraviolet rays emitted from light sources such as a xenon lamp, a low-pressure mercury-vapor lamp, a high-pressure mercury-vapor lamp, an extra-pressure mercury-vapor lamp, a metal halide lamp, a carbon-arc lamp, a tungsten lamp, and the like; and electron rays, α-ray, β-ray, γ-ray, and the like, emitted from particle accelerators of 20 to 2000 kV. Among these, ultraviolet rays or electron rays are preferably used. In particular, ultraviolet rays are preferred. As an ultraviolet source, solar light, a low-pressure mercury-vapor lamp, a high-pressure mercury-vapor lamp, an extra-pressure mercury-vapor lamp, a carbon-arc lamp, a metal halide lamp, a xenon lamp, an argon laser, a helium/cadmium laser, or the like can be used. By using the ultraviolet source, the coating film can be cured by irradiating a coating surface of the active energy ray-curable resin layer with ultraviolet rays at a wavelength of about 180 to 400 nm. The amount of ultraviolet irradiation is appropriately selected according to the type and amount of the photopolymerization initiator used.

In the case of the plastic substrate, heating can be combined within a range having no influence on the plastic substrate. In this case, a known heat source such as hot air, near-infrared rays, or the like can be applied as a heating source.

In the case of ultraviolet curing, it is preferred to use the photopolymerization initiator. As the photopolymerization initiator, a known one may be used, and for example, at least one selected from the group consisting of acetophenones, benzylketals, and benzophenones can be preferably used. Examples of the acetophenones include diethoxyacetophenone, 2-hydroxy-2-methyl-1-phenylpropan-1-one, 1-(4-isopropylphenyl)-2-hydroxy-2-methylpropan-1-one, 4-(2-hydroxyethoxy)phenyl-(2-hydroxy-2-propyl)ketone, and the like. Examples of the benzylketals include 1-hydroxycyclohexyl-phenyl ketone, benzyl dimethylketal, and the like. Examples of the benzophenones include benzophenone, methyl o-benzoylbenzoate, and the like. Examples of the benzoins include benzoin, benzoin methyl ether, benzoin isopropyl ether, and the like. These photopolymerization initiators (B) may be used alone or combination of two or more.

The amount of the photopolymerization initiator (B) used is preferably 1% to 15% by weight, more preferably 2% to 10% by weight, based on 100% by weight of the composite resin (A).

If required, an active energy ray-curable monomer, particularly a multifunctional (meth)acrylate, is preferably contained. Since the polyfunctional (meth)acrylate is reacted with the polyisocyanate (B) as described above, the (meth)acrylate preferably contains an alcoholic hydroxyl group. Examples thereof polyfunctional (meth)acrylates each having two or more polymerizable double bonds per molecule, such as 1,2-ethanediol diacrylate, 1,2-propanediol diacrylate, 1,4-butanediol diacrylate, 1,6-hexanediol diacrylate, dipropylene glycol diacrylate, neopentyl glycol diacrylate, tripropylene glycol diacrylate, trimethylolpropane diacrylate, trimethylolpropane triacrylate, tris(2-acryloyloxy)isocyanurate, pentaerythritol triacrylate, pentaerythritol tetraacrylate, di(trimethylolpropane)tetraacrylate, di(pentaerythritol)pentaacrylate, di(pentaerythritol)hexaacrylate, and the like. Also, urethane acrylate, polyester acrylate, and epoxy acrylate can be exemplified as polyfunctional acrylates. These may be used alone or in combination of two or more.

In particular, pentaerythritol triacrylate and dipentaerythritol pentaacrylate are preferred from the viewpoint of abrasion resistance of the cured coating film and improvement in the cracking resistance due to reaction with the polyisocyanate.

In addition, a monofunctional (meth)acrylate may be combined with the polyfunctional (meth)acrylate. Usable examples thereof include hydroxyl group-containing (meth)acrylates, such as hydroxyethyl (meth)acrylate, hydroxypropyl(meth)acrylate, hydroxybutyl(meth)acrylate, caprolactone-modified hydroxy(meth)acrylate (e.g., trade name “Placcel” manufactured by Daicel Chemical Industries, Ltd.), polyesterdiol mono(meth)acrylate produced from phthalic acid and propylene glycol, polyesterdiol mono(meth)acrylate produced from succinic acid and propylene glycol, polyethylene glycol mono(meth)acrylate, polypropylene glycol mono(meth)acrylate, pentaerythritol tri(meth)acrylate, 2-hydroxy-3-(meth)acryloyloxypropyl(meth)acrylate, (meth)acrylic acid adducts of various epoxyesters, and the like; carboxyl group-containing vinyl monomers, such as (meth)acrylic acid, crotonic acid, itaconic acid, maleic acid, fumaric acid, and the like; sulfonic acid group-containing vinyl monomers, such as vinylsulfonic acid, styrenesulfonic acid, sulfoethyl(meth)acrylate, and the like; acid phosphate vinyl monomers, such as 2-(meth)acryloyloxyethyl acid phosphate, 2-(meth)acryloyloxypropyl acid phosphate, 2-(meth)acryloyloxy-3-chloropropyl acid phosphate, 2-methacryloyloxyethylphenyl malic acid, and the like; and methylol group-containing vinyl monomers, such as N-methylol(meth)acrylamide and the like. These can be used alone or in combination of two or more. In view of reactivity to the isocyanate group of a polyfunctional isocyanate (b), a hydroxy group-containing (meth)acrylate is particularly preferred as a monomer (c).

The amount of the polyfunctional acrylate used is preferably 1% to 85% by weight, more preferably 5% to 80% by weight, based on the total solid content in a resin composition used for the active energy ray-curable resin layer. By using the polyfunctional acrylate within this range, the physical properties such as hardness of the resultant layer can be improved.

On the other hand, when heat curing is combined, a catalyst is preferably selected in view of the reaction temperatures and times of reaction of a polymerizable double bond in the composition and urethane reaction between the alcoholic hydroxyl group and the isocyanate. Also, a thermosetting resin can be combined. Examples of the thermosetting resin include vinyl resins, unsaturated polyester resins, polyurethane resins, epoxy resins, epoxyester resins, acryl resins, phenol resins, petroleum resins, ketone resins, silicone resins, and modified resins thereof.

In addition, if required, various additives such as an organic solvent, an inorganic pigment, an organic pigment, a constitutional pigment, a clay mineral, a wax, a surfactant, a stabilizer, a mobility adjuster, a dye, a leveling agent, a rheology control agent, an ultraviolet absorber, an antioxidant, and a plasticizer can be used.

The thickness of the photocatalyst-supporting sheet of the present invention is not particularly limited, but is preferably 0.1 to 300 μm from the viewpoint that the photocatalyst-supporting sheet having wear resistance and long-term outdoor weatherability can be formed. When the thickness of the sheet is less than 0.1 μm, weatherability and wear resistance cannot be imparted to the substrate, while when the thickness increases to exceed 300 μm, the inside of a coating film is not sufficiently irradiated with ultraviolet rays, and thus poor curing may occur, thereby causing the need for attention. The thickness of the photocatalyst layer constituting the photocatalyst-supporting sheet is preferably 0.01 to 2 μm, more preferably 0.02 to 0.2 μm, because transparency can be secured over a long time.

### (Photocatalyst Layer)

In the present invention, the photocatalyst layer is a layer containing a photocatalyst. The photocatalyst is not particularly limited, and a known photocatalyst which functions as a catalyst when receiving light irradiation can be used. The photocatalyst preferably has a particle shape, and the average particle diameter of the particle is not particularly limited but is preferably 5 to 200 nm, more preferably 10 nm to 100 nm. The average particle diameter is measured using a particle size analyzer (HORIBA, LB-550) utilizing a dynamic light scattering method.

Specific examples of the photocatalyst particles include particles of anatase-type titanium oxide, rutile-type titanium oxide, zinc oxide, tin oxide, ferric oxide, bismuth trioxide, tungsten trioxide, strontium titanate, and combinations thereof. Usable examples thereof include particles of titanium oxide, zinc oxide, tin oxide, iron oxide, zirconium oxide, tungsten trioxide, chromium oxide, molybdenum oxide, ruthenium oxide, germanium oxide, lead oxide, cadmium oxide, copper oxide, vanadium oxide, niobium oxide, tantalum oxide, manganese oxide, rhodium oxide, ferric oxide, nickel oxide, bismuth trioxide, rhenium oxide, strontium titanate, and the like. When titanium oxide is used as the photocatalyst, the crystal form is preferably an anatase type, a rutile type, or a brookite type because the photocatalytic activity is maximized and exhibited over a long period of time. Further, particles of titanium oxide with a crystal structure which is designed to be doped with a heteroelement so as to respond to visible light can also be used. As the doping element for titanium oxide, an anion element such as nitrogen, sulfur, carbon, fluorine, or phosphorus or a cation element such as chromium, iron, cobalt, or manganese is preferably used. As the photocatalyst particles used in the present invention, anatase-type titanium oxide, rutile-type titanium oxide, zinc oxide, tin oxide, ferric oxide, bismuth trioxide, tungsten trioxide, and strontium titanate are more preferred, and a mixture thereof may be used. As the photocatalyst particles used in the present invention, anatase-type titanium oxide can be most preferably used. In addition, as the form of the photocatalyst particles, a powder or a sol or slurry containing an organic solvent or water used for dispersion can be used.

Also, a binder resin is preferably used for the photocatalyst layer in order to fixing the photocatalyst. The binder resin is not particularly limited but is preferably a resin which is not decomposed, choked, or deteriorated by photocatalysis. As such a resin, a resin which has a siloxane bond or a resin which produces a siloxane bond is preferred. Also, a resin containing a double bond is preferred for enhancing adhesion at an interface with the active energy ray-curable resin layer formed as the primer layer. Specifically, as such a resin, it is preferred to used any one of a curable resin (D) containing a silanol group and/or a hydrolyzable silyl group, a curable resin (E) containing a silanol group and/or a hydrolyzable silyl group and a group having a polymerizable double bond, and a curable resin (F) containing a group having a polymerizable double bond. In particular, the curable resin (D) or the curable resin (E) is preferably used.

Preferred examples of the curable resin (D) include curable resins described in Japanese Patent No. 3521431. Specifically, in the composite resin (A), a curable resin not having a polymerizable double bond-containing group is preferred. Also, alkoxysilane or a partial condensate compound thereof can be used. A silicon alkoxide or a condensate thereof is not particularly limited as long as it is alkoxysilane generally used for sol-gel reaction. Examples thereof include tetraalkoxysilanes such as tetramethoxysilane, tetraethoxysilane, tetrapropoxysilane, tetraisopropoxysilane, tetrabutoxysilane, and the like; trialkoxysilanes such as methyl trimethoxysilane, methyl triethoxysilane, methyl tripropoxysilane, methyl tributoxysilane, ethyl trimethoxysilane, ethyl triethoxysilane, n-propyl trimethoxysilane, n-propyl triethoxysilane, isopropyl trimethoxysilane, isopropyl triethoxysilane, vinyl trimethoxysilane, vinyl triethoxysilane, 3-glycidoxypropyl trimethoxysilane, 3-glycidoxypropyl triethoxysilane, 3-mercaptopropyl trimethoxysilane, 3-mercaptopropyl triethoxysilane, phenyl trimethoxysilane, phenyl triethoxysilane, 3,4-epoxycyclohexylethyl trimethoxysilane, 3,4-epoxycyclohexylethyl triethoxysilane, and the like; dimethyl dimethoxysilane; dimethyl diethoxysilane, diethyl dimethoxysilane; diethyl diethoxysilane; and partial condensates thereof. The alkoxysilane or partial condensate thereof may be combined with titanium alkoxide and/or aluminum alkoxide. Examples of the titanium alkoxide include titanium isopropoxide, titanium lactate, titanium triethanolaminate, and the like. Examples of the aluminum alkoxide include aluminum isopropoxide and the like.

For the alkoxysilane or partial condensate thereof, any one of various acid catalysts can be used. Examples thereof include inorganic acids such as hydrochloric acid, boric acid, sulfuric acid, hydrofluoric acid, phosphoric acid, and the like; and organic acids such as acetic acid, phthalic acid, maleic acid, fumaric acid, paratoluenesulfonic acid, and the like. These acids may be used alone or in combination of two or more.

As the curable resin (E), the composite resin (A) or a silane compound containing a silanol group and/or a hydrolyzable silyl group and a polymerizable double bond can be used. Specific examples of the silane compound include vinyl trimethoxysilane, vinyl triethoxysilane, vinylmethyl dimethoxysilane, vinyl tri(2-methoxyethoxy)silane, vinyl triacetoxysilane, vinyl trichlorosilane, 2-trimethoxysilylethyl vinyl ether, 3-(meth)acryloyloxypropyl trimethoxysilane, 3-(meth)acryloyloxypropyl triethoxysilane, 3-(meth)acryloyloxypropylmethyl dimethoxysilane, 3-(meth)acryloyloxypropyl trichlorosilane, and the like. Among these, vinyl trimethoxysilane and 3-(meth)acryloyloxypropyl trimethoxysilane are preferred because hydrolysis reaction can be easily proceeded, and by-products after the reaction can be easily removed.

As the curable resin (F), specifically, an oligomer or polymer containing a (meth)acryloyl group can be used. Examples thereof include polyurethane(meth)acrylate, polyester(meth)acrylate, polyacryl(meth)acrylate, epoxy(meth)acrylate, polyalkylene glycol poly(meth)acrylate, polyether(meth)acrylate, and the like. Among these, polyurethane(meth)acrylate, polyester(meth)acrylate, and epoxy(meth)acrylate are preferred.

Also, an acryl resin, a styrene resin, polyvinyl chloride, polyvinylidene chloride, polyvinyl acetate, or polyester can be used in combination with any one of the curable resins (D) to (F). This resin may be a homopolymer or a copolymer of a plurality of monomers. A thermoplastic resin is preferably nonpolymerizable.

The content of the photocatalyst particles relative to 100 parts by weight of the binder resin is preferably in a range of 10 parts by weight to 800 parts by weight, more preferably 25 parts by weight to 400 parts by weight, because an excessively small amount causes deterioration in uniformity of the photocatalyst layer and decreases the photocatalytic activity, and the photocatalyst function is preferably exhibited.

The thickness of the photocatalyst layer is preferably 0.01 to 2 μm and more preferably 0.02 to 0.2 μm because transparency can be secured over a long time.

When the thickness is set to be equal to or smaller than the average particle diameter of the photocatalyst particles used, the photocatalyst particles are partially exposed in a layer surface, thereby desirably further enhancing the catalytic activity.

### (Method for Producing Photocatalyst-Supporting Sheet)

The photocatalyst-supporting sheet of the present invention is produced by a method of providing, on the substrate, at least the active energy ray-curable resin layer and the photocatalyst layer in that order by a method such as a flow coater, a roll coater, spraying, air-less spraying, air spraying, brushing, roller coating, troweling, dipping, pulling up, nozzle, winding, flowing, setout, or patching, or a transfer method of laminating, by dry lamination, the substrate on which the active energy ray-curable resin layer is provided by dry lamination and a desired release film on which the photocatalyst layer is provided so that the active energy ray-curable resin layer faces the photocatalyst layer. Among these, the transfer method is preferred.

In transfer by dry lamination, the temperature of a lamination roll is preferably normal temperature to about 60° C., and the pressure is preferably about 10 to 60 N/cm². Curing can be performed without a problem by energy ray irradiation with timing of immediately after to about 1 month after the lamination. In the transfer method, curing is performed in a laminated state by irradiation with active energy rays, and thus an ultraviolet-curable resin, which is susceptible to curing inhibition by oxygen, can be sufficiently cured even with an ultraviolet irradiation intensity of as low as about 300 mJ/cm² to 1000 mJ/cm² in terms of integrated irradiation intensity. Therefore, the surface hardness of the finally produced photocatalyst-supporting sheet is increased, thereby desirably further improving wear resistance. The active energy rays may be applied during production, immediately before working, or after working, and the irradiation time may be appropriately selected according to purposes. When the sheet is used as an adhesive sheet, the photocatalyst-supporting sheet of stable quality can be produced by irradiation with active energy rays during production. In this case, aging is more preferably performed to produce silicate bonding derived from the silanol group and/or the hydrolyzable silyl group present in the active energy ray-curable resin layer, thereby further increasing strength. The aging is generally performed at normal temperature for 1 week but heat aging is often performed at 40° C. for about 1 to 3 days. The active energy rays are preferably applied without separating the release sheet.

On the other hand, when the photocatalyst-supporting sheet of the present invention is used as an inset molding sheet, the sheet before irradiation with the active energy rays is preferably used because of excellent easy moldability. In this case, the photocatalyst-supporting sheet before irradiation with the active energy rays is fixed in a mold, integrally molded by injection molding, and then irradiated with the active energy rays, thereby producing a molded product with a photocatalyst layer provided on a surface and excellent in mold following, wear resistance, and long-term weatherability.

The method for providing the active energy ray-curable resin layer and the photocatalyst layer on the support film or the method for providing the photocatalyst layer on a desired release film is not particularly limited. For example, any one of various printing methods such as gravure printing, offset printing, gravure offset printing, flexographic printing, screen printing, and the like, and various known coating methods such as gravure coating, micro-gravure coating, roll coating, rod coating, kiss coating, knife coating, air knife coating, comma coating, die coating, lip coating, flow coating, dip coating, spray coating, and the like can be appropriately used.

The desired release film is not particularly limited as long s the photocatalyst layer can be provided, thermal deterioration does not occur by dry lamination, and the film can be satisfactorily separated from the photocatalyst layer before use. Specific examples of such a film include films of thermoplastic resins such as polyolefin resins, e.g., polyethylene, polypropylene, and the like; olefin copolymer resins, e.g., ethylene-vinyl acetate copolymers, ethylene-vinyl alcohol copolymers, ethylene-(meth)acrylic acid (ester)copolymers, metal-neutralized ethylene-unsaturated carboxylic acid copolymers (so-called ionomer resins), and the like; acryl resins, e.g., polyacrylonitrile, polymethyl methacrylate, polyethyl methacrylate, and the like; styrene resins, such as polystyrene, AS resins, ABS resins, and the like; polyvinyl resins, e.g., polyvinyl acetal, polyvinyl chloride, polyvinylidene chloride, polyvinyl acetate, vinyl chloride-vinyl acetate copolymers, and the like; polyester resins, e.g., polyethylene terephthalate, polybutylene terephthalate, polyethylene naphthalate, polyarylate, polycarbonate, and the like; and fluorocarbon resins, such as polyvinyl fluoride, polyvinylidene fluoride, polytetrafluoroethylene, ethylene-tetrafluoroethylene copolymers, and the like. These films may be exposed to plasma or surface-treated with a release agent such as a fluorine-based compound, a silicone compound, or the like.

The photocatalyst layer can be formed on the release film by gravure printing, offset printing, screen printing, ink jet printing, gravure coating, or micro-gravure coating. The micro-gravure coating capable of forming a thin film and uniform coating film or the gravure printing capable of forming a coating film at a high speed is preferred. The dry thickness of the photocatalyst layer is preferably 0.01 to 2 μm, more preferably 0.02 to 0.2 μm.

As described above, the active energy ray-curable resin layer and the photocatalyst layer are provided by the coating method, and thus a diluent such as an organic solvent is preferably used for dilution during production. Examples of the organic solvent include aliphatic or alicyclic hydrocarbons, such as n-hexane, n-heptane, n-octane, cyclohexane, cyclopentane, and the like; aromatic hydrocarbons, such as toluene, xylene, ethylbenzene, and the like; alcohols, such as methanol, ethanol, n-butanol, ethylene glycol monomethyl ether, propylene glycol monomethyl ether, and the like; esters, such as ethyl acetate, butyl acetate, n-butyl acetate, n-amyl acetate, ethylene glycol monomethyl ether acetate, propylene glycol monomethyl ether acetate, and the like; ketones, such as acetone, methyl ethyl ketone, methyl isobutyl ketone, methyl n-amyl ketone, cyclohexanone, and the like; polyalkylene glycol dialkyl ethers, such as diethylene glycol dimethyl ether, diethylene glycol dibutyl ether, and the like; ethers, such as 1,2-dimethoxyethane, tetrahydrofuran, dioxane, and the like; N-methylpyrrolidone; dimethyl formamide; dimethyl acetamide; and ethylene carbonate. These can be used alone or in combination of two or more.

When a resin having a polymerizable double bond, specifically the curable resin (E) or the curable resin (F), is used for the photocatalyst layer, the photocatalyst layer is adhered to the active energy ray-curable resin layer before complete curing of the active energy ray-curable resin layer, and in this state, the active energy ray-curable resin layer is completely cured to react the polymerizable double bonds in the active energy ray-curable resin layer and the photocatalyst layer, thereby producing a sheet with excellent adhesion between both layers. The active energy ray-curable resin layer before complete curing may be put in a completely uncured state or a partially cured state, i.e., a wet state, by irradiation with ultraviolet rays or electron rays in a fraction of the amount that can cause complete curing.

On the other hand, when the curable resin (D) or the curable resin (E) which produces a siloxane bond of a silanol group and/or a hydrolyzable silyl group is used, since the composite resin (A) in the active energy ray-curable resin layer also contains a silanol group and/or a hydrolyzable silyl group, silanol groups and/or hydrolyzable silyl groups in both the active energy ray-curable resin layer and the photocatalyst layer gradually react at an interface therebetween after production of a sheet, thereby producing the sheet with excellent adhesion at the interface. However, in this case, the reaction proceeds with time, and thus the adhesion at the interface in an early stage tends to be poor.

When the curable resin (E), i.e., the composite resin (A), is used for the photocatalyst layer, since the composite resin (A) contains both the polymerizable double bond and the silanol group and/or the hydrolyzable silyl group, the two types of bonding occurs at the interface. Therefore, preferably, interfacial adhesion in an early stage is excellent, and interfacial adhesion over time is also excellent.

A specific example of the method for producing the photocatalyst-supporting sheet of the present invention is a method using a micro-gravure coater provided with a UV irradiation device. That is, an organic solvent solution of an energy ray-curable resin is applied on the substrate using a micro-gravure roll, and the organic solvent is removed with a drying furnace. Then, the substrate is laminated on the previously prepared release film so as to face the photocatalyst layer formed on the release film using a thermocompression bonding roll set to predetermined temperature and pressure. The resultant laminate is irradiated with ultraviolet rays at predetermined integrated irradiation intensity and wound on a take-up roll to produce the photocatalyst-supporting sheet of the present invention.

On the other hand, similarly, an example of the method for forming the photocatalyst layer on the release film is a method using a micro-gravure coater. That is, an organic solvent solution of the photocatalyst and the binder is applied on the release film, and the organic solvent is removed with a drying furnace. Then, the film is wound on a take-up roll.

### (Adhesive Layer)

In addition, any desired layer can be further laminated within a range in which the advantages of the present invention are not impaired. For example, an adhesive layer or tacky layer is preferably provided on a surface of the substrate layer on the side opposite to the active energy ray-curable resin layer. The adhesive layer or tacky layer is a layer which is provided for enhancing adhesive force to an adherend. A material which can be bonded to the resin film and the adherend can be appropriately selected regardless of whether an adhesive or a tackiness agent.

Examples of the adhesive include acryl resins, urethane resins, urethane-modified polyester resins, polyester resins, epoxy resins, ethylene-vinyl chloride copolymer resins (EVA), vinyl chloride resins, vinyl chloride-vinyl acetate copolymer resins, natural rubber, synthetic rubbers such as SBR, NBR, and silicone rubber, crystalline polymers, and the like. A solvent type or solvent-less type can be used.

Any tackiness agent can be used as long as it has tackiness at a thermoforming temperature. Examples thereof include solvent-type tackiness agents such as acryl resins, isobutylene rubber resins, styrene-butadiene rubber resins, isoprene rubber resins, natural rubber resins, silicone resins, and the like; and solvent-less tackiness agents such as acryl emulsion resins, styrene butadiene latex resins, natural rubber latex resins, styrene-isoprene copolymer resins, styrene-butadiene copolymer resins, styrene-ethylene-butylene copolymer resins, ethylene-vinyl acetate resins, polyvinyl alcohols, polyacrylamide, polyvinyl methyl ether, and the like.

When the adhesive layer or tacky layer is provided on the photocatalyst-supporting sheet of the present invention, the photocatalyst-supporting sheet can be produced by a method of applying an adhesive or a tackiness agent on a surface of the substrate of the photocatalyst-supporting sheet on the side opposite to the active energy ray-curable resin layer.

### (Usage)

The resultant photocatalyst-supporting sheet with the adhesive layer or the tacky layer can be attached to an adherend. If required, the sheet can be water-activated by spraying water or water containing a surfactant to an interface of the adherend. Also, the sheet can be attached by an extrusion lamination method or a re-heating lamination method.

The adherend to which the photocatalyst-supporting sheet of the present invention can be attached is not particularly limited, and the sheet can be attached to articles composed of various materials. Examples of the adherend include plastic moldings of thermosetting resins, thermoplastic resins, fiber-reinforced plastics, and the like; various glass moldings of sodium soda glass, heat-resistant glass, quartz glass, and the like; inorganic moldings such as fiber-reinforced cement boards, ceramic siding boards, wood wool cement boards, pulp cement boards, slates, wood wool cement laminates, plaster boards, clay roof tiles, pressed cement roof tiles, ceramic tiles, water-glass decorative sheets, and the like; metal moldings such as rolled steel sheets, aluminum and aluminum ally sheets, hot-dipped galvanized steel sheets, rolled stainless steel sheets, tinplate sheets, and the like; and composite moldings thereof. The photocatalyst-supporting sheet can be attached during factory production and/or site work in a building site or the like.

The adherend preferably has a shape having a smooth adhesion surface, such as a plate-like shape or a sheet-like shape, in view of easy attachability, but the shape is not particularly limited. For example, even when the adherend has a shape with an irregular surface, no problem occurs as long as the photocatalyst-supporting sheet can be attached along the surface. In particular, when the adherend is a plastic molding, a raw resin is molded to a predetermined shape by integrally molding the resin and the photocatalyst-supporting sheet previously fixed in a mold so that the sheet can be attached to a relatively complicated surface. For example, the substrate side of the photocatalyst-supporting sheet is fixed to the cavity surface of a female die for vacuum molding or injection molding, and then the film softened by heating is adhered to the molding surface of the female die by reduced pressure. Then, a male die is combined with the female die, and a molten resin is injected to integrate the photocatalyst-supporting sheet with a resin molding to be formed in a predetermined shape.

The adherend to which the photocatalyst-supporting sheet is attached is excellent in wear resistance and long-term outdoor weatherability (particularly, chalking resistance and cracking resistance) and thus can be used as an external-application self cleaning sheet for, for example, a window glass, an exterior wall material, a roof material, a storm sash, or a tent. By using a visible light photocatalyst, a room-air cleaning effect and an antibacterial and sterilizing effect are exhibited, and the sheet can be preferably used for electric appliances such as an air cleaner filter, a refrigerator, an air conditioner, and a sweeper, and various illumination devices.

### (Protective Sheet for Solar Cell)

The photocatalyst-supporting sheet of the present invention can be directly used as a light receiving surface-side protective sheet for a solar cell. It is preferable to use a plastic substrate and the photocatalyst-supporting sheet with the adhesive layer or tacky layer.

### (Solar Cell Module)

A specific example of a form of a solar cell module is described, in which the photocatalyst-supporting sheet of the present invention is used as a light receiving surface-side protective sheet for a solar cell. Of course, the present invention includes various embodiments not described here.

A solar cell module includes a light-receiving surface-side protective sheet for a solar cell, a first sealing material, a solar cell group, a second sealing material, and a rear-side protective sheet for a solar cell, which are laminated in order. The light-receiving surface-side protective sheet for a solar cell is laminated so that the plastic substrate of the protective sheet faces the first sealing material, i.e., the photocatalyst layer of the photocatalyst-supporting sheet of the present invention is the outermost layer.

The first sealing material and the second sealing material seal the solar cell group between the light-receiving surface-side protective sheet for a solar cell and the rear-side protective sheet for a solar cell. As the first sealing material and the second sealing material, a light-transmitting resin, such as an ethylene-vinyl acetate copolymer (referred to as “EVA”), EEA, PVB, silicon, urethane, acryl, or epoxy, can be used. The first sealing material and the second sealing material each contain a crosslinking agent such as a peroxide. Therefore, when the first sealing material and the second sealing material are heated to a predetermined crosslinking temperature or more, crosslinking starts after softening. As a result, the constituent members are temporarily bonded together.

The solar cell group includes a plurality of solar cells and a wiring material. The plurality of solar cells are electrically connected to each other through the wiring material.

Then, the first sealing material and the second sealing material which are laminated with a laminator are finally cured by heating to produce the solar cell module.

### EXAMPLES

Next, the present invention is specifically described with reference to examples and comparative examples. In the examples, “parts” and “%” are based on weight unless otherwise specified.

### Synthesis Example 1

### Synthesis Example of Polysiloxane

In a reactor provided with a stirrer, a thermometer, a dropping funnel, a condenser tube, a nitrogen gas inlet, 415 parts of methyl trimethoxysilane (MTMS) and 756 parts of 3-methacryloyloxypropyl trimethoxysilane (MPTS) were charged, and the resultant mixture was heated to 60° C. under stirring in a nitrogen gas stream. Then a mixture containing 0.1 part of “A-3” (isopropyl acid phosphate, manufactured by Sakai Chemical Industry Co., Ltd.) and 121 parts of deionized water was added dropwise over 5 minutes. After the completion of addition, the reactor was heated to 80° C. and hydrolysis-condensation reaction was effected by stirring for 4 hours, producing a reaction product.

Methanol and water contained in the resultant reaction product were removed under the conditions of a reduced pressure of 1 to 30 kilopascal (kPa) and 40° C. to 60° C., thereby producing 1,000 parts of polysiloxane (a1-1) having a number-average molecular weight of 1,000 and an effective component content of 75%.

The effective component content was a value obtained by dividing a theoretical yield (parts by weight) for hydrolysis-condensation reaction of all methoxy groups of the silane monomer used by an actual yield (parts by weight) after hydrolysis-condensation reaction, i.e., a value obtained by calculation according to the equation [theoretical yield (parts by weight) for hydrolysis-condensation reaction of all methoxy groups of silane monomer used/actual yield (parts by weight) after hydrolysis-condensation reaction].

### Synthesis Example 2

### Synthesis Example of Polysiloxane

In the same reactor as in Synthesis Example 1, 442 parts of MTMS and 760 parts of 3-acryloyloxypropyl trimethoxysilane (APTS) were charged, and the resultant mixture was heated to 60° C. under stirring in a nitrogen gas stream. Then a mixture containing 0.1 part of “A-3” and 129 parts of deionized water was added dropwise over 5 minutes. After the completion of addition, the reactor was heated to 80° C. and hydrolysis-condensation reaction was effected by stirring for 4 hours, producing a reaction product. Methanol and water contained in the resultant reaction product were removed under the conditions of a reduced pressure of 1 to 30 kilopascal (kPa) and 40° C. to 60° C., thereby producing 1,000 parts of polysiloxane (a1-2) having a number-average molecular weight of 1,000 and an effective component content of 75.0%.

### Synthesis Example 3

### Synthesis Example of Composite Resin A

In the same reactor as in Synthesis Example 1, 20.1 parts of phenyl trimethoxysilane (PTMS), 24.4 parts of dimethyl dimethoxysilane (DMDMS), and 107.7 parts by n-butyl acetate were charged, and the resultant mixture was heated to 80° C. under stirring in a nitrogen gas stream. Then, a mixture containing 15 parts of methyl methacrylate (MMA), 45 parts of n-butyl methacrylate (BMA), 39 parts of 2-ethylhexyl methacrylate (EHMA), 1.5 parts of acrylic acid (AA), 4.5 parts of MPTS, 45 parts of 2-hydroxyethyl methacrylate (HEMA), 15 parts of n-butyl acetate, and 15 parts of tert-butylperoxy-2-ethyl hexanoate (TBPEH) was added dropwise to the reactor over 4 hours under stirring at the same temperature in a nitrogen gas stream. Further, the resultant mixture was stirred at the same temperature for 2 hours, and then a mixture of 0.05 part of “A-3” and 12.8 parts of deionized water was added dropwise to the reactor over 5 minutes. Then, hydrolysis-condensation reaction of PTMS, DMDMS, and MPTS was proceeded by stirring at the same temperature for 4 hours. As a result of ¹H-NMR analysis of the reaction product, about 100% of the trimethoxysilyl groups of the silane monomer in the reactor were hydrolyzed. Next, stirring was performed at the same temperature for 10 hours to produce a reaction product with a TBPEH residual amount of 0.1% or less. The TBPEH residual amount was measured by iodometry.

Next, 162.5 parts of the polysiloxane (a1-1) produced in Synthesis Example 1 was added to the reaction product, and the resultant mixture was stirred for 5 minutes. Then, 27.5 parts of deionized water was added to the mixture, followed by stirring at 80° C. for 4 hours to perform hydrolysis-condensation reaction between the reaction product and the polysiloxane. The produced methanol and water were removed by distilling the obtained reaction product for 2 hours under the conditions of a reduced pressure of 10 to 300 kPa and 40° C. to 60° C. Next, 150 parts of methyl ethyl ketone (MEK) and 27.3 parts of n-butyl acetate were added to prepare 600 parts of composite resin (A-1) having a nonvolatile content of 50.0% and including a polysiloxane segment and a vinyl polymer segment.

### Synthesis Example 4

### Synthesis Example of Composite Resin A

In the same reactor as in Synthesis Example 1, 20.1 parts of PTMS, 24.4 parts of DMDMS, and 107.7 parts by n-butyl acetate were charged, and the resultant mixture was heated to 80° C. under stirring in a nitrogen gas stream. Then, a mixture containing 15 parts of MMA, 45 parts of BMA, 39 parts of EHMA, 1.5 parts of AA, 4.5 parts of MPTS, 45 parts of HEMA, 15 parts of n-butyl acetate, and 15 parts of TBPEH was added dropwise to the reactor over 4 hours under stirring at the same temperature in a nitrogen gas stream. Further, the resultant mixture was stirred at the same temperature for 2 hours, and then a mixture of 0.05 part of “A-3” and 12.8 parts of deionized water was added dropwise to the reactor over 5 minutes. Then, hydrolysis-condensation reaction of PTMS, DMDMS, and MPTS was proceeded by stirring at the same temperature for 4 hours. As a result of ¹H-NMR analysis of the reaction product, about 100% of the trimethoxysilyl groups of the silane monomer in the reactor were hydrolyzed. Next, stirring was performed at the same temperature for 10 hours to produce a reaction product with a TBPEH residual amount of 0.1% or less. The TBPEH residual amount was measured by iodometry.

Next, 562.5 parts of the polysiloxane (a1-1) produced in Synthesis Example 1 was added to the reaction product, and the resultant mixture was stirred for 5 minutes. Then, 80.0 parts of deionized water was added to the mixture, followed by stirring at 80° C. for 4 hours to perform hydrolysis-condensation reaction between the reaction product and the polysiloxane. The produced methanol and water were removed by distilling the obtained reaction product for 2 hours under the conditions of a reduced pressure of 10 to 300 kPa and 40° C. to 60° C. Next, 128.6 parts of MEK and 5.8 parts of n-butyl acetate were added to prepare 857 parts of composite resin (A-2) having a nonvolatile content of 70.0% and including a polysiloxane segment and a vinyl polymer segment.

### Synthesis Example 5

### Synthesis Example of Composite Resin A

In the same reactor as in Synthesis Example 1, 20.1 parts of PTMS, 24.4 parts of DMDMS, and 107.7 parts by n-butyl acetate were charged, and the resultant mixture was heated to 80° C. under stirring in a nitrogen gas stream. Then, a mixture containing 15 parts of MMA, 45 parts of BMA, 39 parts of EHMA, 1.5 parts of AA, 4.5 parts of MPTS, 45 parts of HEMA, 15 parts of n-butyl acetate, and 15 parts of TBPEH was added dropwise to the reactor over 4 hours under stirring at the same temperature in a nitrogen gas stream. Further, the resultant mixture was stirred at the same temperature for 2 hours, and then a mixture of 0.05 part of “A-3” and 12.8 parts of deionized water was added dropwise to the reactor over 5 minutes. Then, hydrolysis-condensation reaction of PTMS, DMDMS, and MPTS was progressed by stirring at the same temperature for 4 hours. As a result of ¹H-NMR analysis of the reaction product, about 100% of the trimethoxysilyl groups of the silane monomer in the reactor were hydrolyzed. Next, stirring was performed at the same temperature for 10 hours to produce a reaction product with a TBPEH residual amount of 0.1% or less. The TBPEH residual amount was measured by iodometry.

Next, 162.5 parts of the polysiloxane (a1-2) produced in Synthesis Example 2 was added to the reaction product, and the resultant mixture was stirred for 5 minutes. Then, 27.5 parts of deionized water was added to the mixture, followed by stirring at 80° C. for 4 hours to perform hydrolysis-condensation reaction between the reaction product and the polysiloxane. The produced methanol and water were removed by distilling the obtained reaction product for 2 hours under the conditions of a reduced pressure of 10 to 300 kPa and 40° C. to 60° C. Next, 150 parts of MEK and 27.3 parts of n-butyl acetate were added to prepare 600 parts of composite resin (A-3) having a nonvolatile content of 50.0% and including a polysiloxane segment and a vinyl polymer segment.

### Synthesis Example 6

### Synthesis Example of Composite Resin A

In the same reactor as in Synthesis Example 1, 191 parts of PTMS was charged and heated to 120° C. under stirring in a nitrogen gas stream. Then, a mixture containing 169 parts of MMA, 11 parts of MPTS, and 18 parts of TBPEH was added dropwise to the reactor over 4 hours under stirring at the same temperature in a nitrogen gas stream. Further, the resultant mixture was stirred at the same temperature for 16 hours to prepare an acryl polymer containing a trimethoxysilyl group.

Next, the temperature of the reactor was adjusted to 80° C., and 131 parts of MTMS, 226 parts of APTS, and 116 parts of DMDMS were added to the reactor under stirring. Then, a mixture of 6.3 parts of “A-3” and 97 parts of deionized water was added dropwise to the reactor over 5 minutes. Then, hydrolysis-condensation reaction was proceeded by stirring at the same temperature for 2 hours to produce a reaction product. As a result of ¹H-NMR analysis of the reaction product, about 100% of the trimethoxysilyl groups of the acryl polymer were hydrolyzed. Next, the produced methanol and water were removed by distilling the obtained reaction product for 2 hours under the conditions of a reduced pressure of 10 to 300 kPa and 40° C. to 60° C. Next, 400 parts of n-butyl acetate was added to prepare 600 parts of composite resin (A-4) having a nonvolatile content of 60% and including a polysiloxane segment and a acryl polymer segment.

### Synthesis Example 7

### Synthesis Example of Comparative Composite Resin R-1

In the same reactor as in Synthesis Example 1, 250 parts of xylene and 250 parts of n-butyl acetate were charged, and the resultant mixture was heated to 80° C. under stirring in a nitrogen gas stream. Then, a mixture containing 500 parts of styrene, 123 parts of BMA, 114 parts of BA, 3 parts of AA, 230 parts of HEMA, 30 parts of MPTS, 178 parts of xylene, 178 parts of n-butyl acetate, and 50 ports of TBPEH was added dropwise to the reactor over 4 hours at the same temperature under stirring in a nitrogen gas stream. Then, stirring was performed at the same temperature for 16 hours to prepare an acryl polymer containing a trimethoxysilyl group.

Next, in the same reactor as in Synthesis Example 1, 509 parts of methyl triethoxysilane (MTES), 389 parts of MTMS, 71 parts of PTMS, 129 parts of DMDMS, 298 parts of xylene, and 296 parts of n-butyl acetate were charged, and the resultant mixture was heated to 80° C. under stirring in a nitrogen stream. Then, a mixture of 0.03 parts of “A-3” and 347 parts of deionized water was added dropwise to the reactor over 5 minutes at the same temperature. Then, stirring was performed at the same temperature for 4 hours to produce a reaction product. As a result of ¹H-NMR analysis of the reaction product, it was confirmed that hydrolysis of MTES, MTMS, PTMS, and DMDMS proceeded.

Then, 905 parts of the acryl polymer was added to the reactor, followed by stirring at the same temperature for 4 hours to produce a reaction product. Next, the produced methanol and water were removed by distilling the obtained reaction product for 2 hours under the conditions of a reduced pressure of 10 to 300 kPa and 40° C. to 60° C. to prepare 1000 parts of comparative composite resin (R-1) having a nonvolatile content of 50.0%. This synthesis example was performed according to Reference Example 23 described in Examples of International Publication No. 96/035755 pamphlet.

### Synthesis Example 8

### Synthesis Example of Curable Resin (D)

First, 1.5 parts of ion-exchange water and 8 parts of 2-propanol (hereinafter referred to as “IPA”) were stirred and mixed, and then 3.9 parts of a 10% aqueous maleic acid solution was slowly added dropwise. The pH of the mixture was 2.6. Then, a mixture containing 14.4 parts of a tetramethoxysilane condensate (methyl silicate 51: manufactured by Colcoat Co., Ltd., hereinafter referred to as “MS-51”) and 4.4 parts of 3-glycidoxypropyl trimethoxysilane (hereinafter referred to as “GPTMS”) was gradually added, followed by stirring for 1 hour to prepare 32.2 parts by weight of curable resin (D).

The composite resin (A-1) was used as the curable resin (E), and urethane acrylate “Unidic 17-813” (manufactured by DIC Corporation) was used as the curable resin (F).

### Synthesis Example 9

### Synthesis Example of Comparative Curable Resin R-2

On the basis of description in Patent Literature 3, energy ray-curable polysiloxane-modified urethane(meth)acrylate resin (R-2) was synthesized as described below.

In a reactor provided with a stirrer, a thermometer, a dropping funnel, a condenser tube, and a nitrogen gas inlet, 20 parts of butyl acetate as a solvent and 100 parts by weight of hydroxyl group-containing polydimethylsiloxane (BY16-201, manufactured by Dow Corning Toray Silicone Co., Ltd.) were charged, and the resultant mixture was heated to 80° C. under stirring in a nitrogen gas stream. Then, 220 parts by weight of polyisocyanate “Burnock DN-901S” (manufactured by DIC Corporation) was added dropwise over 5 minutes. After the completion of addition, 550 parts by weight of hydroxyl group-containing (meth)acrylate (PETA: pentaerythritol triacrylate) was further charged, and the inside the reactor was held at 80° C. and stirred for 4 hours to effect addition reaction, thereby producing reaction product (R-2).

### PREPARATION EXAMPLE

### Preparation of Resin Compositions (P-1) to (P-5), (Comparative P-1), and (Comparative P-2) for Active Energy Ray-Curable Resin Layer

First, 40.0 parts of the composite resin (A-1) prepared in Synthesis Example 1, 0.8 parts of a photopolymerization initiator “Irgacure 184” (manufactured by Ciba Specialty Chemicals Co., Ltd.), and 4.2 parts of polyisocyanate “Burnock DN-901S” (manufactured by DIC Corporation) were mixed and uniformly stirred to prepare resin composition (P-1) for an active energy ray-curable resin layer.

Similarly, resin compositions (P-2) to (P-5), (comparative P-1), and (comparative P-2) for active energy ray-curable resin layers were prepared on the basis of compositions shown in Table 1.

TABLE 1
Resin composition of active energy ray-curable resin layer

| | | | | | | | | Comp. | Comp. |
|---|---|---|---|---|---|---|---|---|---|
| | | | P-1 | P-2 | P-3 | P-4 | P-5 | P-1 | P-2 |
| Active | Composite resin | (A-1) | 40 | 40 | | | | | |
| energy ray- | | (A-2) | | | 28.6 | | | | |
| curable | | (A-3) | | | | 10 | | | |
| resin layer | | (A-4) | | | | | 30 | | |
| | Reference resin | (R-1) | | | | | | 40 | |
| | (a1) content (%)*1 | | 40 | 24 | 40 | 12.1 | 67 | 51 | 0 |
| | Polyisocyanate | DN-901S | 4.2 | | | 1 | | | |
| | | DN-950 | | 17.3 | 5.2 | | | | |
| | (B) content (%)*2 | | 17 | 31 | 10 | 5 | 0 | 0 | 0 |
| | Polyfunctional | PETA | | 8 | | | | | |
| | acrylate | DPHA | | | 12.4 | | | | |
| | | 17-813 | | | | 16.9 | | | 16.9 |
| | Photo- | 1-184 | 0.8 | 1.1 | 1.3 | 0.37 | 1.2 | | 0.27 |
| | polymerization | 1-127 | | | | 0.37 | | | 0.27 |
| | initiator | | | | | | | | |

*1Content (%) of polysiloxane segment (a1) based on the total solid content of the curable resin composition.
*2Content (%) of polyisocyanate (B) based on the total solid content of the curable resin composition.
17-813: Unidic 17-813 (urethane acrylate, manufactured by DIC Corporation)
PETA: Pentaerythritol triacrylate
DPHA: Dipentaerythritol hexaacrylate
1-184: Irgacure 184 (photopolymerization initiator, manufactured by Ciba Japan Co., Ltd.)
1-127: Irgacure 127 (photopolymerization initiator, manufactured by Ciba Japan Co., Ltd.)

17-813: Unidic 17-813 (urethane acrylate, manufactured by DIC Corporation)

PETA: Pentaerythritol triacrylate

DPHA: Dipentaerythritol hexaacrylate

1-184: Irgacure 184 (photopolymerization initiator, manufactured by Ciba Japan Co., Ltd.)

1-127: Irgacure 127 (photopolymerization initiator, manufactured by Ciba Japan Co., Ltd.)

### PREPARATION EXAMPLE

### Preparation of Compositions (PC-1) to (PC-5) for Photocatalyst Layer

A photocatalyst coating material (PC-1) was prepared by mixing 10 parts of the composite resin (A-1) produced as the curable resin (E) in Synthesis example 3, 0.2 part of Irgacure 184, 312 parts of IPA as a dilution solvent, and 43 parts of photocatalyst slurry “TKD 701” (manufactured by Tayca Corporation) as photocatalyst particles, and stirring the resultant mixture.

Similarly, (PC-2) to (PC-4) were prepared on the basis of the compositions shown in Table 2.

On the other hand, (PC-5) was prepared on the basis of a composition example described in Patent Literature 3.

TABLE 2
Resin composition of photocatalyst layer

| | | | PC-1 | PC-2 | PC-3 | PC-4 | PC-5 |
|---|---|---|---|---|---|---|---|
| Photo- | Curable | (D)NV 30% | | | 16 | | |
| catalyst | compound | (E)NV 50% | 10 | 5 | | | |
| layer | | (F)NV 80% | | | | 6 | 2.4 |
| | | 17-813 | | | | | |
| | Reference | (R-2)NV | | | | | 3.6 |
| | resin | 98% | | | | | |
| | Poly- | DPHA | | 5 | | | |
| | functional | | | | | | |
| | acrylate | | | | | | |
| | Photo- | 1-184 | 0.2 | 0.3 | | 0.1 | 0.3 |
| | poly- | 1-127 | | | | 0.1 | |
| | merization | | | | | | |
| | initiator | | | | | | |
| | Dilution | IPA | 312 | 470 | 312 | 320 | 340 |
| | solvent | | | | | | |
| | Photocatalyst | TKD 701 | 43 | 64.5 | 43 | 43 | 43 |
| | particle | | | | | | |

| | | | | | |
|---|---|---|---|---|---|
| Photocatalyst/binder | 1.5 | 1.5 | 1.5 | 1.5 | 1.3 |

In this table, curable compound D is the curable resin (D) produced in Synthesis Example 8, curable compound E is the composite resin (A-1), and curable resin (F) is urethane acrylate “Unidic 17-813 (manufactured by DIC Corporation).

### Example 1

### Method for Producing Photocatalyst-Supporting Sheet

Step 1: The photocatalyst layer composition (PC-1) prepared in the preparation example was applied on an olefin film “Pylen P2002” (manufactured by Toyobo Co., Ltd.) as a substrate with bar coater #3 and then dried to form a photocatalyst layer (PC-1) having a thickness of 0.1 μm.

Step 2: The primer (P-1) prepared in the preparation example was applied on a PET film “Cosmoshine A4300” (thickness 50 μm, manufactured by Toyobo Co., Ltd.) with bar coater #20 and then dried at 40° C. for 10 minutes to form an active energy ray-curable resin layer (P-1) having a thickness of 20 μm.

Step 3: The active energy ray-curable resin layer (P-1) with a wet surface and the photocatalyst layer (PC-1) formed in the step 1 were laminated in contact with each other under lamination conditions (temperature 40° C., pressure 40 N/cm²) to form a laminated sheet.

Step 4: The laminated sheet formed in the step 3 was irradiated with active energy rays using a mercury lamp of a lamp output of 1 kW under the condition of an integrated intensity of 300 mJ/cm² to cure the active energy ray-curable resin layer (P-1). Since the composite resin (A-1) was used as the curable resin (E) in the photocatalyst resin layer composition (PC-1), the photocatalyst resin layer composition (PC-1) was also cured. Then, the olefin film was separated to form a photocatalyst-supporting sheet (1).

### Example 2 to Example 10

Photocatalyst-supporting sheets (2) to (8) were produced by the same method as in Example 1 except that the active energy ray-curable resin layer and the photocatalyst layer were as shown in Table 3.

### Comparative Example 1

A photocatalyst-supporting sheet (H1) was produced by the same method as in Example 1 except that the active energy ray-curable resin layer and the photocatalyst layer were as shown in Table 4 and, in the step 4 of example 1, curing was performed at normal temperature for 7 days without irradiation with active energy rays.

### Comparative Example 2

A photocatalyst-supporting sheet (H2) was produced based on an embodiment of Patent Literature 3.

### <Method for Evaluating Photocatalyst-Supporting Sheet>

### [Surface Mechanical Properties, Whitening Resistance]

In the photocatalytic activity test (1), when a sample before a sunshine weatherometer test reached a limit contact angle, the sample was immersed in hot water of 40° C. for 168 hours, sufficiently dried at normal temperature, and then rubbed with black drawing paper at a load of 500 g/cm² to evaluate white powder transferred on the black drawing paper by visual observation. A sample producing transfer of white powder was evaluated as “Poor”, and a sample producing no transfer of white powder was evaluated as “Good”.

### [Surface Mechanical Properties, Crack Resistance (SWOM)]

An accelerated weatherability test was conducted with a sunshine weatherometer manufactured by Suga Test Instruments Co., Ltd. and an unexposed specimen and a specimen after exposure for 3000 hours were compared by visual observation. A specimen without changes of a surface condition, etc. was evaluated to “Good”, a specimen producing partially cracks was evaluated as “Fair”, and a specimen producing cracks over the entire surface was evaluated as “Poor”.

### [Surface Mechanical Properties, Crack Resistance (MW)]

An accelerated weatherability test was conducted by a metal weather test using DMW manufactured by Daipla Wintes Co., Ltd. and an unexposed specimen and a specimen after exposure for 480 hours were compared by visual observation. A specimen without changes of a surface condition, etc. was evaluated to “Good”, a specimen producing partially cracks was evaluated as “Fair”, and a specimen producing cracks over the entire surface was evaluated as “Poor”. This evaluation method is to measure crack resistance under severer conditions than the accelerated weatherability test for evaluating the crack resistance (SWOM) and is a test method for materials intended for long-term outdoor use.

### [Surface Mechanical Properties, Chalking Resistance]

An accelerated weatherability test was conducted with a sunshine weatherometer, and a specimen after exposure for 3000 hours was evaluated according to the same procedure as for the whitening resistance. That is, a specimen was rubbed with black drawing paper at a load of 500 g/cm², and white powder transferred to the black drawing paper was evaluated by visual observation. A sample producing transfer of white powder was evaluated as “Poor”, and a sample producing no transfer of white powder was evaluated as “Good”.

### [Surface Mechanical Properties, Haze Value]

An accelerated weatherability test was conducted with a sunshine weatherometer, and a degree of deterioration of a specimen was quantified by a haze value. A haze value (unit: %) is usually calculated according to the equation below using a light transmittance of a specimen measured with a haze meter.

Th=Td/Tt(Td is scattering light transmittance, Tt is total light transmittance) [Equation 1]

Here, a difference between a haze value (%) of a specimen after the passage of 3000 hours and a haze value (%) of an untested specimen is indicated as haze value change ΔH (%). It is known that the larger the difference is, the more the deterioration of a specimen proceeds.

### [Surface Mechanical Properties, Wear Resistance]

The surface of the photocatalyst layer on the photocatalyst-supporting sheet was rubbed in a taper abrasion test by a method according to JIS R3212 (abrasion wheel: SC-10F, load: 500 g, number of rotations: 200) to measure a difference in haze value, i.e., haze value change ΔH (%), from an initial state. It is known that the smaller the haze difference is, the higher the wear resistance is.

### [Surface Mechanical Properties, Adhesion Resistance]

An accelerated weatherability test (3000 hours) was conducted with a sunshine weatherometer, and adhesion between the photocatalyst layer, the energy ray-curable resin layer, and the substrate of the photocatalyst-supporting sheet was evaluated by a cross-cut test (JIS K5600) using a lattice of 100 squares of 1 mm×1 mm. A number of squares remaining after separation of a cellophane tape was determined.

### [Photocatalytic Activity Test (1), Measurement of Water Contact Angle]

A self cleaning performance test was conducted by a method according to JIS R 1703-1 (2007) except that oleic acid was not applied, and a limit contact angle of a specimen was measured after irradiation with ultraviolet light for 3000 hours using a sunshine weatherometer.

It is known that the smaller the limit contact angle is, the higher the photocatalytic activity is.

### [Photocatalytic Activity Test (2), Wet Decomposition Performance]

A decomposition coefficient of methylene blue in a specimen was calculated before and after exposure for 3000 hours with a sunshine weatherometer according to JIS R 1703-(2007).

It is known that the higher the decomposition coefficient is, the hither the photocatalytic activity.

Table 3 shows the sheet configurations and evaluation results of Examples 1 to 8, and Table 4 shows the sheet configurations and evaluation results of Comparative Examples 1 and 2.

TABLE 3
Evaluation list of physical properties of examples

| | | | | | | | | | Exam- | Exam- |
|---|---|---|---|---|---|---|---|---|---|---|
| | | | Example 1 | Example 2 | Example 3 | Example 4 | Example 5 | Example 6 | ple 7 | ple 8 |
| Sheet | Active energy ray-curable resin layer | | P-1 | P-2 | P-2 | P-3 | P-4 | P-5 | P-2 | P-2 |
| configuration | Photocatalyst layer | | PC-1 | PC-1 | PC-2 | PC-1 | PC-1 | PC-1 | PC-3 | PC-4 |
| Physical | Surface | Whitening resistance | Good | Good | Good | Good | Good | Good | Good | Good |
| properties of | mechanical | Crack resistance (SWOM) | Good | Good | Good | Good | Good | Good | Good | Good |
| coating | properties | Crack resistance (MW) | Good | Good | Good | Good | Good | Fair | Good | Fair |
| | | Chalking resistance (SWOM) | Good | Good | Good | Good | Good | Good | Good | Good |
| | | Haze value | 0.8 | 0.9 | 1.0 | 0.8 | 1.1 | 0.8 | 0.9 | 1.0 |
| | | Wear resistance | 6 | 5 | 4 | 3 | 4 | 5 | 6 | 7 |
| | | Adhesion | 100 | 100 | 100 | 100 | 100 | 100 | 100 | 100 |
| | Photo- | Limit contact angle (°)*3 | 4 | 4 | 5 | 3 | 5 | 5 | 6 | 5 |
| | catalytic | Limit contact angle (°)*4 | 6 | 5 | 6 | 5 | 6 | 8 | 7 | 8 |
| | activity | Decomposition index R*3 | 15 | 14 | 13 | 14 | 13 | 13 | 12 | 13 |
| | | Decomposition index R*4 | 13 | 13 | 11 | 13 | 10 | 11 | 11 | 12 |

SWOM: Abbreviation of sunshine weatherometer test
MW: Abbreviation of metal weather test
*3Measured value before sunshine weatherometer test
*4Measured value after sunshine weatherometer test

TABLE 4
Evaluation list of physical properties of comparative examples

| | | | Comparative | Comparative |
|---|---|---|---|---|
| | | | Example 1 | Example 2 |
| Sheet | Active energy ray- | | Comparative | Comparative |
| configu- | curable resin layer | | P-1 | P-2 |
| ration | Photocatalyst layer | | PC-3 | PC-5 |
| Physical | Surface | Whitening | Poor | Good |
| properties | mechanical | resistance | | |
| of coating | properties | Crack resistance | Good | Poor |
| | | (SWOM) | | |
| | | Crack resistance | Good | Poor |
| | | (MW) | | |
| | | Chalking | Good | Poor |
| | | resistance | | |
| | | (SWOM) | | |
| | | Haze value | 1.0 | 15 |
| | | Wear resistance | 40 | 7 |
| | | Adhesion | 50 | 0 |
| | Photo- | Limit contact | 5 | 5 |
| | catalytic | angle (°)*3 | | |
| | activity | Limit contact | 6 | 45 |
| | | angle (°)*4 | | |
| | | Decomposition | 13 | 13 |
| | | index R*3 | | |
| | | Decomposition | 10 | 2 |
| | | index R*4 | | |

According to the results, the photocatalyst-supporting sheets (1) to (5) produced in Examples 1 to 5, respectively, have no problem with whitening resistance, wear resistance, and crack resistance, chalking resistance, and adhesion resistance in the long-term weatherability test and also maintain photocatalytic activity. The photocatalyst-supporting sheet (6) produced in Example 6 does not contain isocyanate in the active energy-ray curable resin layer and thus partially causes cracks in the metal weather test which is an accelerated weatherability test under the severest conditions, but the cracks are at a level of no problem in application of outdoor practical use. The photocatalyst-supporting sheet (8) produced in Example 8 does not contain silicon as a photocatalyst binder and thus partially causes cracks in the metal weather test, but the cracks are at a level of no problem in application of outdoor practical use.

On the other hand, the photocatalyst-supporting sheet (H1) produced in Comparative Example 1 in which the active energy ray-curable resin layer does not contain a polymerizable double bond causes incomplete curing in an early stage and shows poor whitening resistance and wear resistance.

The photocatalyst-supporting sheet (H2) produced in Comparative Example 2 in which general-purpose acrylate is used as a primer causes deterioration of the primer by oxidation of the photocatalyst, thereby causing significant decrease in weatherability (crack resistance, chalking resistance, and adhesion) and photocatalytic activity.

### Example 9

### Method for Producing Solar Cell Module

### (Preparation of Sealing Material)

### (Preparation of Sealing Material for Solar Cell)

A sealing material composition of a solar cell was prepared by kneading 100 parts of EVA (ethylene-vinyl acetate copolymer (vinyl acetate content 28% by weight)) and 1.3 parts of 2,5-dimethyl-2,5-di(2-ethylhexanoylperoxy)hexane with a roll mill at 70° C. The prepared sealing material composition for a solar cell was calender-molded at 70° C. and allowed to cool to form a sealing material for a solar cell (thickness 0.6 mm).

### (Formation of Back Straight-Type Solar Cell Module)

A heating plate of a lamination device (manufactured by Nisshinbo Mechatronics Co., Ltd.) was adjusted to 150° C., and an aluminum plate, the sealing material for a solar cell, a polycrystalline silicon soar cell, the sealing material for a solar cell, and the photocatalyst-supporting sheet (1) produced in Example 1 as a light-receiving surface-side protective sheet for a solar cell were laminated in that order. In the lamination device closed with a cover, deaeration for 3 minutes and pressing for 8 minutes were performed in order, and then the resultant laminate was maintained for 10 minutes and then taken out as a back straight-type solar cell module (F-1).

### (Evaluation of Power Generation Efficiency)

The power generation efficiency (%) of the solar cell module (F-1) was measured using a solar simulator manufactured by Wacom Electric Co., Ltd. under the conditions of a module temperature of 25° C., a radiation strength of 1 kW/m², spectral distribution AM 1.5 G. Here, a difference between a generation efficiency (%) after exposure for 3000 hours with the sunshine weatherometer and a generation efficiency (%) of an untested module is indicated. It is known that as the larger the difference is, the more the deterioration of the photocatalyst-supporting sheet proceeds.

Difference in generation efficiency (%)=initial generation efficiency (%)−generation efficiency after accelerated weatherability test (%) [Equation 2]

### Comparative Example 3

A solar cell module (HF-1) was produced by the same method as in Example 9 except that the photocatalyst-supporting sheet (H2) produced in Comparative Example 2 was used in place of the photocatalyst-supporting sheet (1) produced in Example 1.

Table 5 shows the module names and differences in power generation efficiency of Example 9 and Comparative Example 3.

TABLE 5

| | Example 9 | Comparative Example 3 |
|---|---|---|
| Solar cell module | F-1 | HF-1 |
| Difference in generation | 0.5 | 3.0 |
| efficiency (%) | | |

According to the results, the solar cell module of Example 9 using the photocatalyst-supporting sheet (1) of Example 1 as the light-receiving surface-side protective sheet for a solar cell has no problem with crack resistance, chalking resistance, and adhesion resistance in the long-term weatherability test and has a clear surface due to the hydrophilic effect of the photocatalyst and substantially maintains the initial power generation efficiency. On the other hand, the solar cell module of Comparative Example 3 using the photocatalyst-supporting sheet (H2) produced in Comparative Example 2 in which general-purpose acrylate is used for a primer causes significant decrease in weatherability (crack resistance, chalking resistance, and adhesion) and photocatalytic activity due to deterioration of the primer by oxidation of the photocatalyst, thereby causing a significant decrease in the power generation efficiency.

1. A photocatalyst-supporting sheet comprising at least an active energy ray-curable resin layer and a photocatalyst layer which are provided in that order on a substrate,
wherein the active energy ray-curable resin layer contains a composite resin (A) in which a polysiloxane segment (a1) and a vinyl polymer segment (a2) are bonded through a bond represented by general formula (3), the polysiloxane segment having a structural unit represented by general formula (1) and/or general formula (2) and having a silanol group and/or a hydrolyzable silyl group, and the vinyl polymer segment (a2) having an alcoholic hydroxyl group; and a polyisocyanate (B). 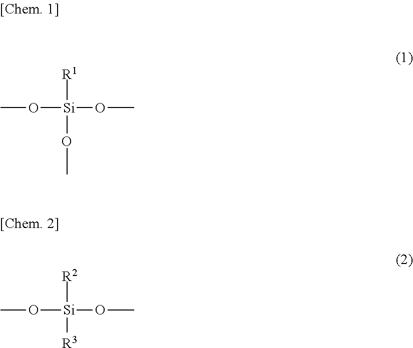
(in the general formulae (1) and (2), R¹, R², and R³ each independently represent a group having one polymerizable double bond selected from the group consisting of —R⁴—CH═CH₂, —R⁴—C(CH₃)═CH₂, —R⁴—O—CO—C(CH₃)═CH₂, and —R⁴—O—CO—CH═CH₂ (wherein R⁴ represents a single bond or an alkylene group having 1 to 6 carbon atoms), an alkyl group having 1 to 6 carbon atoms, a cycloalkyl group having 3 to 8 carbon atoms, an aryl group, or an aralkyl group having 7 to 12 carbon atoms, and at least one of R¹, R², and R³ is the group having a polymerizable double bond), 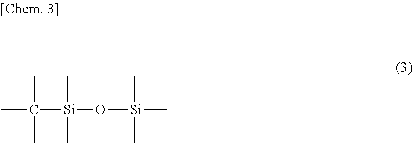
(in the general formula (3), a carbon atom constitutes a portion of the vinyl polymer segment (a2), and a silicon atom bonded only to an oxygen atom constitutes a portion of the polysiloxane segment (a1)).

2. (canceled)

3. The photocatalyst-supporting sheet according to claim 1, wherein the content of the polysiloxane segment (a1) is 10% to 65% by weight based on the total solid content of the active energy ray-curable resin layer, and the content of the polyisocyanate (B) is 5% to 50% by weight based on the total solid content of the active energy ray-curable resin layer.

4. The photocatalyst-supporting sheet according to claim 1, wherein the number-average molecular weight of the vinyl polymer segment (a2) is in a range of 1,000 to 50,000.

5. The photocatalyst-supporting sheet according to claim 1, wherein the photocatalyst layer contains a curable resin (D) having a silanol group and/or a hydrolyzable silyl group, a curable resin (E) having a silanol group and/or a hydrolyzable silyl group and a polymerizable double bond, or a curable resin (F) having a polymerizable double bond.

6. A primer for a photocatalyst-supporting sheet including a plastic substrate, the primer comprising an active energy ray-curable resin layer composition which contains a composite resin (A) in which a polysiloxane segment (a1) and a vinyl polymer segment (a2) are bonded through a bond represented by general formula (3), the polysiloxane segment (a1) having a structural unit represented by general formula (1) and/or general formula (2) and having a silanol group and/or a hydrolyzable silyl group, and the vinyl polymer segment (a2) having an alcoholic hydroxyl group; and a polyisocyanate (B). 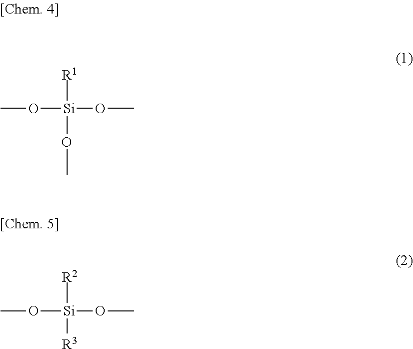
(in the general formulae (1) and (2), R¹, R², and R³ each independently represent a group having one polymerizable double bond selected from the group consisting of —R⁴—CH═CH₂, —R⁴—C(CH₃)═CH₂, —R⁴—O—CO—C(CH₃)═CH₂, and —R⁴—O—CO—CH═CH₂ (wherein R⁴ represents a single bond or an alkylene group having 1 to 6 carbon atoms), an alkyl group having 1 to 6 carbon atoms, a cycloalkyl group having 3 to 8 carbon atoms, an aryl group, or an aralkyl group having 7 to 12 carbon atoms, and at least one of R¹, R², and R³ is the group having a polymerizable double bond)
[Chem. 6] 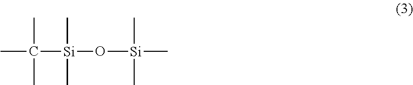
(in the general formula (3), a carbon atom constitutes a portion of the vinyl polymer segment (a2), and a silicon atom bonded only to an oxygen atom constitutes a portion of the polysiloxane segment (a1)).

7. The photocatalyst-supporting sheet according to claim 3, wherein the photocatalyst layer contains a curable resin (D) having a silanol group and/or a hydrolyzable silyl group, a curable resin (E) having a silanol group and/or a hydrolyzable silyl group and a polymerizable double bond, or a curable resin (F) having a polymerizable double bond.
